(19) United States
(12) Patent Application Publication
(10) Pub. No.: US 2023/0364616 A1
(43) Pub. Date: Nov. 16, 2023

(54) IMPROVEMENTS IN OR RELATING TO A DEVICE AND METHODS FOR FACILITATING MANIPULATION OF MICRODROPLETS

(71) Applicant: LIGHTCAST DISCOVERY LTD, Cambridge, Cambridgeshire (GB)

(72) Inventors: Evangelia-Nefeli ATHANASOPOULOU, Cambridge, Cambridgeshire (GB); James BUSH, Cambridge, Cambridgeshire (GB); William DEACON, Cambridge, Cambridgeshire (GB); Richard Jeremy INGHAM, Cambridge, Cambridgeshire (GB); Thomas ISAAC, Cambridge, Cambridgeshire (GB); Ibrahim Saygin TOPKAYA, Cambridge, Cambridgeshire (GB); Emma TALBOT, Cambridge, Cambridgeshire (GB)

(73) Assignee: LIGHTCAST DISCOVERY LTD, Cambridge, Cambridgeshire (GB)

(21) Appl. No.: 18/030,132

(22) PCT Filed: Oct. 5, 2021
(86) PCT No.: PCT/GB2021/052567

§ 371 Date: Apr. 4, 2023

(30) Foreign Application Priority Data
Oct. 5, 2020 (GB) 2015733.5
Oct. 5, 2020 (GB) 2015744.2
Oct. 5, 2020 (GB) 2015754.1

(51) Int. Cl. B01L 3/00

(52) U.S. Cl. CPC B01L 3/502792; B01L 3/502715; B01L 2200/027

(57) ABSTRACT

An apparatus for manipulating one or more microdroplets into an array using EWOD or oEWOD is provided. The apparatus comprises: a) a chip for manipulating microdroplets comprising: i) a plurality of electrowetting pathways leading to the array; and ii) one or more waste electrowetting pathways leading to a waste outlet; b) a detector for detecting one or more microdroplets with a distinct characteristic, said detector configured to obtain a measured dataset relating to the distinct characteristic of the detected microdroplet; c) a storage module configured to store and maintain a stored dataset associated with the characteristic measured by the detector; and d) a controller configured to receive the stored dataset from the storage module and the obtained measured dataset to determine whether the measured dataset is associated with a desired or undesired characteristic. The controller is configured to select one or more microdroplets having a measured dataset that is associated with an undesired characteristic and cause the one or more selected microdroplets to move into a waste electrowetting pathway. Furthermore, the controller is configured to control the motion of the microdroplets along and/or between the electrowetting pathways such that the movement of the microdroplets is synchronised.

### FIELD OF THE INVENTION

The present invention relates to a device and method for facilitating the manipulation of microdroplets and in particular, a device and method for loading one or more microdroplets into a microfluidic chip.

### BACKGROUND

Electrowetting-on-dielectric (EWOD) is a well-known effect in which an electric field applied between a liquid and a substrate makes the liquid more wetting on the surface than the natural state. The effect of electrowetting can be used to manipulate microdroplets (e.g., controlling the movement, merging, splitting or changing shape of microdroplets) by applying a series of spatially varying electrical fields on a substrate to increase the surface wettability following the spatial variations in a sequence. Droplets manipulated in electrowetting-based devices are typically sandwiched between two parallel plates and actuated by digital electrodes. The size of pixelated electrodes limits the minimum droplet size that can be manipulated as well as the rate and scale at which droplets can be processed in parallel.

A variant of this approach uses optically-mediated electrowetting forces, known in the art as optoelectrowetting, to provide the motive force in a device for manipulating microdroplets. In this optically mediated electrowetting (oEWOD) device, the microdroplets are translocated through a microfluidic space defined by containing walls; for example a pair of parallel plates having the microfluidic space sandwiched therebetween. At least one of the containing walls includes what are hereinafter referred to as ‘virtual’ electrowetting electrode locations which are generated by selectively illuminating an area of a semiconductor layer buried within. By selective illumination of the layer with light from a separate light source, controlled by an optical assembly, a virtual pathway of virtual electrowetting electrode locations can be generated transiently along which the microdroplets can be caused to move. Thus conductive cells are dispensed with and permanent droplet-receiving locations are abandoned in favour of a homogeneous dielectric surface on which the droplet-receiving locations are generated ephemerally by selective and varying illumination of points on the photoconductive layer using for example a pixelated light source. This enables highly localised electrowetting fields capable of moving the microdroplets on the surface by induced capillary-type forces to be established anywhere on the dielectric layer; optionally in association with any directional microfluidic flow of the carrier medium in which the microdroplets are dispersed; for example by emulsification.

In one example, an application of EWOD and oEWOD devices is in the pharmaceutical industry, in the fields of cell line development and antibody development. In these fields there is a need to allow for initial screening of a large number of biological agents (up to millions) to enable the reduction of the number of agents down to sensible numbers (thousands). To achieve an efficient workflow this initial screen needs to take place across a large number of biological agents in a multiplexed fashion.

Therefore a crucial aspect of EWOD or oEWOD devices intended for application in these fields, is ability to process large numbers of droplets, from hundreds, thousands up to the order of millions, at once. Existing EWOD and oEWOD devices have practical limitations to the number of droplets that can be processed in parallel within a single field of view due to the use of microscope optics to address the sample. Existing devices are limited to the processing of a few thousand droplets at once.

Essential features of an EWOD or oEWOD device capable of processing and manipulating droplets to the order of millions include, a large number of optical manipulation spots, a scaled-up chip, and the ability to load millions of droplets into the device quickly and reliably.

Existing options for loading droplets into EWOD and oEWOD devices rely on either manual user intervention which is suitable for pumping small batches of droplets into the chip, pulling droplets out of a flowing stream at one edge of the chip which can suffer from performance issues owing to imprecise control of droplet speed, or devices can be designed in which droplets are loaded into a holding pen in batches before being ejected. In the former, the maximum flow speed is limited by the maximum droplet EWOD or oEWOD speed, and large areas of the device are wasted. The latter approach is inherently a batch process and is thus susceptible to the issues this inherently implies due to process switching times.

Therefore, there is a requirement to provide a device and method to quickly and efficiently load multiple microdroplets onto the chip. In addition, there is also a need to load the droplets into the chip such that the droplets can readily and easily be manipulated by EWOD or oEWOD force.

Furthermore, populations of droplets loaded into an EWOD or oEWOD device, may contain a substantial fraction of droplets which are unsuitable to be assayed. For example, the droplet may have an undesirable size which makes it difficult to select and manipulate using EWOD or oEWOD forces. In order to maximise the space capacity with desired droplets within the device, it is important to be able to remove undesired droplets as early as possible in the loading process, so that the unwanted droplets do not occupy space within the chip. Alternatively, the content of the droplet may be undesirable. For example, in an assay which requires a starting point of a single cell per droplet, any droplets which are empty or contain multiple cells are undesirable. Removing droplets which do not meet acceptable content criteria increases the yield of useful droplets retained for the assay.

Therefore, there is a requirement to provide a device and method which can facilitate the control and manipulation of millions of microdroplets by EWOD or oEWOD force efficiently, whilst optimising the use of space on the chip. Moreover, there is a requirement to provide a device, apparatus and/or a method which can quickly and efficiently identify and separate undesired droplets from millions of droplets loaded into a chip. It is desirable for the device to be able to adapt to the removal of the undesired droplets, and maintain a consistent yield of droplets in an array, even when large numbers of undesired droplets are removed from the device. Furthermore, providing a fast and efficient apparatus for removing undesired droplets from the chip early in the droplet manipulation process is highly desirable.

It is against this background that the present invention has arisen.

### SUMMARY OF INVENTION

According to the first aspect of the invention, there is provided a device comprising: i) a chip comprising a first region for manipulating a plurality of microdroplets; ii) a microdroplet source for providing the microdroplets; iii) a channel having a distal end, which extends in a first direction into the chip, and a proximal end, which is in fluid communication with the microdroplet source; and iv) a pressure source for moving the microdroplets from the microdroplet source along the channel and into the first region of the chip; wherein the pressure source is configured to enable the movement of the microdroplets from the microdroplet source into the proximal end of the channel at a first velocity; and wherein the distal end of the channel is fluted or blunted such that the microdroplets move from the distal end of the channel into the first region of the chip at a velocity which is lower than the first velocity.

In some embodiments, the microdroplet source can be a reservoir for holding microdroplets. In some embodiments, the microdroplet source can be a droplet generator, such as an emulsifier device, for generating droplets.

In some embodiments, the pressure source for moving the microdroplets is a pump. The pump may be configured to apply a negative pressure at the outlet and/or a positive pressure at the microdroplet source to move the microdroplets.

In some embodiments, the device comprising: i) a chip comprising a first region for manipulating one or more microdroplets; ii) a reservoir for holding one or more microdroplets; iii) a channel extending in a first direction into the chip in fluid communication with the reservoir and the first region, iv) means for moving one or more microdroplets between the reservoir and the first region of the chip; and v) at least one outlet provided in the chip; wherein, the channel, the first region and the at least one outlet are configured to allow one or more microdroplets to flow from the reservoir to the first region at a first velocity; and for said one or more microdroplets to move in the first region at a velocity which is lower than the first velocity.

In some embodiments, there is provided a droplet generator for generating one or more microdroplets, which can be in fluid communication with the chip. The droplet generator can be an emulsifier device for generating droplets. In some embodiments, the emulsifier device can be a step emulsifier device. This can be advantageous because the step emulsifier device can continuously operate to generate large quantities of droplets. Therefore, providing a droplet generator such as an emulsifier device is particularly useful for generating large quantities of microdroplets over a long period of time. The droplet generator can be in fluid communication with the chip via a channel extending in a first direction into the chip. Microdroplets generated by the droplet generator can then move into the first region of the chip by the actuation of the pressure source. It is an advantage to use a droplet generator because there is no requirement to pipette the droplets once they have been created. The droplet generator can be provided within the apparatus of the present invention. It will be appreciated by the skilled person that any forms of droplet generator can be used. It will further be appreciated by the skilled person that any forms of emulsifier device can be used to generate droplets which can then be transported into chip.

Alternatively or additionally to the droplet generator, the apparatus of the present invention can be provided with a reservoir for holding one or more microdroplets.

The device configured to allow one or more microdroplets to move in the first region at a velocity which is lower than the first velocity, is necessary to force the droplets to an effective stop once they enter the first region of the device. This is important to efficiently remove the droplets from flow and take control of the droplets in the device using EWOD or oEWOD. The device according to any aspect disclosed in the present invention can be used to process large numbers of microdroplets in the order of hundreds to millions.

The device provided herein can further comprise two or more outlets provided in the chip. In some embodiments, at least one outlet is positioned on either side of the channel. The provision of outlets in the chip enables a directional flow from the inlet to the outlets. The outlets are optional for the case where microdroplets are loaded into the chip and then parked without any specific unloading scheme. In some embodiments, the outlets are provided for priming purposes, but they are then closed throughout the loading process and remain closed through subsequent operations.

In some embodiments, the channel of the device provided herein comprises a proximal end in which one or more microdroplets move from the droplet source into the channel, and a distal end, in which one or more microdroplets moves from the channel into the first region of the chip.

In some embodiments, the distal end of the channel may be blunted or fluted, i.e. the final section of the channel tapers inwards or outward, respectively to create a section with a different cross sectional area from the channel in order to modify the speed of the microdroplets passing therethrough. In some embodiments, the flare angle of the blunted or fluted end is 0 to <90°. The flare angle of the blunted or fluted end can be more than 0, 10, 20, 30, 40, 50, 60, 70 or 80°. In some embodiments, the flare angle of the blunted or fluted end can be less than 90, 80, 70, 60, 50, 40, 30, 20, 10, or 5°. Preferably, the angle can be 45° or 75°. In some embodiments, the walls of the channel at the distal channel end may be rounded or it may be squared.

To lower the velocity in the first region, the distal channel end extending into the first region of the device may be blunted or fluted. The change in geometry as the blunted or fluted channel end meets the first region facilitates a rapid decrease in flow velocity, which causes droplets to effectively stop upon reaching the distal channel end. This enables loading of the droplets at a maximum speed, without compromising efficient EWOD or oEWOD operation and control of droplets. A high flow rate is detrimental to EWOD or oEWOD operation, as the EWOD or oEWOD force has to overcome the flow. Therefore reducing the velocity of droplets enables effective EWOD or oEWOD operation, and also enables space efficiency on device. It will be appreciated to the skilled person that the distal end of the channel can be of any suitable shape to facilitate a rapid decrease in flow velocity.

In some embodiments, the channel of the device provided herein extends into the chip by a distance of 1000 μm or greater. This ensures the distal channel end is situated at a sufficient distance away from the outlets to facilitate a rapid decrease in flow rate.

In some embodiments, the part of the channel that protrudes into the first region of the device can have a length between 1000 to 20000 μm. In some embodiments, the protrusion length of the channel can be more than 1000, 1200, 1400, 1600, 1800, 2000, 2200, 2400, 2600, 2800, 3000, 3200, 3400, 3600, 3800, 4000, 4200, 4400, 4600, 4800, 5000, 5200 or 5400 μm. In some embodiments, the protrusion length of the channel may be less than 5500, 5400, 5200, 5000, 4800, 4600, 4400, 4200, 4000, 3800, 3600, 3400, 3200, 3000, 2800, 2600, 2400, 2200, 2000, 1800, 1600, 1400 or 1200 μm. The minimum channel length may be 250 μm. A minimum channel length may necessary to create an area of low flow velocity at the distal channel end and prevent a substantial component of the flow travelling directly between the channel end and outlets, which would prevent droplets from effectively stopping upon reaching the distal channel end. In some embodiments a minimum fan length is used to create a reverse in flow direction that inherently leads to a decrease in the microdroplet velocity at the end of the channel.

In some embodiments, the channel of the device provided herein, has a distance between the channel and at least one outlet of 1500 μm or greater. In some embodiments, the channel of the device provided herein, has a distance between the channel and at least one outlet between 3600 to 5600 μm. In some embodiments, the distance between the channel and at least one outlet can be more than 3600, 3700, 3800, 3900, 4000, 4100, 4200, 4300, 4400, 4500, 4600, 4700, 4800, 4900, 5000, 5100, 5200, 5300, 5400, 5500 or even up to 11200 μm. In some embodiments the distance between the channel and at least one outlet can be less than 5600, 5500, 5400, 5300, 5200, 5100, 5000, 4900, 4800, 4700, 4600, 4500, 4400, 4300, 4200, 4100, 4000, 3900, 3800 or 3700 μm. Sufficient separation of the distal channel end and outlets is required to prevent a substantial component of the flow travelling directly between the distal channel end and outlets, which would prevent the droplets from achieving a rapid decrease in flow rate at the distal channel end.

In some embodiments, the channel of the device provided herein may be tapered. In other embodiments, the width of the channel is substantially the same along its entire length. In some embodiments, the width of the channel is between 300 μm and 25 mm. In some embodiments the width of the channel can be greater than 20, 40, 60, 80, 100, 120, 140, 160, 180, 200, 220, 240, 260, 280, 300, 320, 340, 360, 380, 400, 420, 460, 480, 500, 520, 540, 560, 580, 600, 620, 640, 660, 680 μm. In some embodiments the width of the channel can be less than 700, 680, 660, 640, 620, 600, 580, 560, 540, 520, 500, 480, 460, 440, 420, 400, 380, 360, 340, 320, 300, 280, 260, 240, 220, 200, 180, 160, 140, 120, 100, 80, 60 or 40 μm. In some embodiments the width of the channel can be up to several millimeters in width. The minimum channel width is equal to the minimum droplet diameter so as not to compress or distort the droplets when loading into the channel. The maximum channel length is limited by the outlet position and space within the chip.

In some embodiments of the device provided herein, the first velocity is equivalent to a flow rate of between 0.1 to 100 μL/min. In some embodiments the flow rate can be more than 0.1, 0.2, 0.3, 0.4, 0.5, 0.6, 0.7, 0.8 or 0.9, 1, 5, 10, 20, 30, 40, 50, 60, 70, 80 or 90 μL/min. In some embodiments the flow rate can be less than 100, 90, 80, 70, 60, 50, 40, 30, 20, 10, 5, 1.0, 0.9, 0.8, 0.7, 0.6, 0.5, 0.4, 0.3 or 0.2 μL/min. In other embodiments, the first velocity is equivalent to a flow rate of between 0.1 to 0.4 μL/min. In some embodiments the flow rate can be more than 0.10, 0.15, 0.20, or 0.25 μL/min. In some embodiments the flow rate can be less than 0.40, 0.35, 0.30, 0.25, 0.20 or 0.15 μL/min.

In some embodiments of the device provided herein, the velocity of microdroplets in the first region may be 25-5000 μm/s. In some embodiments, the velocity of microdroplets can be more than 25, 50, 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 1900 or 1950 μm/s. In some embodiments, the velocity of the microdroplets can be less than 2000, 1950, 1900, 1850, 1800, 1750, 1700, 1650, 1600, 1550, 1500, 1450, 1400, 1350, 1300, 1250, 1200, 1150, 1100, 1050, 1000, 950, 900, 850, 800, 750, 700, 650, 600, 550, 500, 450, 400, 350, 300, 250, 200, 150, 100 or 50 μm/s. This enables the EWOD or oEWOD force to effectively manipulate the droplets, and facilitates self-organisation of the droplets through EWOD or oEWOD control and subsequent ordered array formation.

In some embodiments of the device provided herein, the surface area of the first region can be greater than the internal surface area of the channel.

In some embodiments of the device provided herein, the means for moving one or more microdroplets can be a pressure source such as a pump. In some embodiments, the pump may be configured to apply negative pressure at the outlet and/or positive pressure at the reservoir to move one or more microdroplets. In some embodiments, the pump is configured to apply negative pressure at the outlet to move one or more microdroplets.

In some embodiments of the device provided herein, the average spherical microdroplet diameter can be 20-200 μm. In some embodiments, the average microdroplet diameter can be more than 20, 30, 40, 50, 60, 70, 80, 90, 100, 110, 120, 130, 140, 150, 160, 170, 180 or 190 μm. In some embodiments, the average microdroplet diameter can be less than 200, 190, 180, 170, 160, 150, 140, 130, 120, 110, 100, 90, 80, 70, 60, 50, 40 or 30 μm. In another embodiment, the average microdroplet diameter is 50-100 μm. In some embodiments, the average microdroplet diameter can be more than 50, 55, 60, 65, 70, 75, 80, 85, 90 or 95 μm. In some embodiments, the average microdroplet diameter can be less than 100, 95, 90, 85, 80, 75, 70, 65, 60 or 55 μm.

In some embodiments of the device provided herein, the chip may be an EWOD chip. In some embodiments, the chip is an oEWOD chip.

In some embodiments, the chip comprises a second region comprising desired array locations in which microdroplets move from the first region of the chip to the second region via a plurality of electrowetting pathways created by an application of ephemeral EWOD or oEWOD force at positions along the pathway. A plurality of electrowetting pathways created through ephemeral EWOD or oEWOD force can enable microdroplets to be moved continuously and facilitates the parallelised loading and manipulation of droplets within the chip.

In some embodiments, the device provided herein may further comprise a microprocessor configured to provide one or more electrowetting pathways and be able to synchronise the movement of each microdroplet in the pathways relative to the others.

In some embodiments of the device provided herein, microdroplets in the first region are disordered and microdroplets in the second region are ordered. In terms of ordering the microdroplets, multiple microdroplets may be arranged in a series of parallel rows.

In some embodiments, the detection of one or more microdroplets may utilize light or optical spectroscopy such as fluorescence spectroscopy. In some embodiments, a detector can be configured to detect the fluorescence of one or more microdroplets. In some embodiments, the detector can be a fluorescence detector.

In a further aspect of the present invention, there is provided a method of loading microdroplets into a chip for manipulation, the method comprising: a) providing a device as described herein; b) moving one or more microdroplets from the reservoir to the first region via the channel extending in the first direction; and c) manipulating microdroplets in the first region; wherein one or more microdroplets flow from the reservoir to the first region at a first velocity; and said one or more microdroplets move in the first region at a velocity which is lower than the first velocity.

In some embodiments, the rate of loading of microdroplets into the chip may be greater than 35/s or even 70/s. This enables full loading of the device efficiently, for example millions of microdroplets can be loaded into the device in less than 8 hours, possibly even 4 hours.

According to another aspect of the invention, there is provided a device for manipulating many hundreds or thousands of microdroplets into an array using EWOD or oEWOD, the device comprising: i) a chip comprising a first region for receiving and manipulating microdroplets; a second region comprising the array and a plurality of electrowetting pathways leading to the array; ii) a microdroplet source configured to provide microdroplets of a predetermined target diameter; iii) a channel configured to provide fluid communication between the microdroplet source and the first region of the chip; and iv) a pressure source configured to move the microdroplets between the microdroplet source and the first region of the chip; wherein the electrowetting pathways on the chip are centre to centre separated by at least double the predetermined target diameter of the microdroplets from the microdroplet source; and wherein the controller is configured to enable synchronous movement of the microdroplets in the electrowetting pathways by application of EWOD or oEWOD force.

The pressure source may be configured to apply positive or negative pressure to push or draw the microdroplets from the microdroplet source into the first region of the chip.

Providing electrowetting pathways that are at least double the average microdroplet diameter can be advantageous to allow a single microdroplet to pass between two other microdroplets. This is required in order to enable droplets which are not controlled by EWOD or oEWOD force to fall between the gaps of the microdroplets which are controlled by EWOD or oEWOD force. Therefore, this is required to achieve a sieving effect and for self-organising droplets. The sieving effect is a surprising technical effect that has arisen from the present invention. The sieving effect can be optimised by moving the droplets at the maximum speed possible with the available EWOD force, this forces only droplets that have an optimum sprite-droplet overlap to be retained and hence causes each sprite to control a single droplet, thus driving self organisation. This process can be additionally optimised in EWOD by reducing the droplet holding potential for this section of the path, in oEWOD this can be achieved by reducing the incident electromagnetic radiation for the sprites. When utilising EWOD this decrease in holding affinity can be achieved in various ways, including but not limited to, alteration of the ethereal electrodes shape, a reduction in the applied field, a shift in the AC frequency. This reduction in holding quality is particularly useful when applied in the self-assembly region because it limits the time droplets spend moving close to their maximum speed to just this region, thus allowing droplets to move comfortably below their maximum speed along the rest of the path without changing speed. This is crucial for maximising droplet retention and droplet loading rates. The reason a decrease in droplet velocity after self-assembly is unfavourable is because it decreases the droplet-droplet spacing which can cause control of the droplets to be lost, droplet-droplet collisions or changes to the droplet holding potential. For oEWOD the illumination intensity in the self-assembly region could be between 0.01 and 0.99 of the intensity utilised along the rest of the pathway. In very high quality devices, corresponding to low probability of accidental droplet loss, a higher initial light intensity such as between 0.75 and 0.99, for example 0.8, can be used. This allows a higher loading speed to be used. In lower quality devices, which have a correspondingly increased probability of droplet loses, a lower ratio of light intensities must be used, such as 0.01 to 0.5, this allows the risk of droplet losses to be minimised further but impairs the maximum loading speed. In other devices it may be optimum to utilise a light intensity ratio between 0.5 and 0.75. Additionally or alternatively, the gap provided between the electrowetting pathways can help reduce or minimise the risk of droplets from different electrowetting pathways coming into contact with each other. The spacing between the electrowetting pathways may enable droplets to efficiently and continuously move along the pathways until the droplets are screened and selected by a user or by an automated software controller for manipulation. The operation is particularly effective when dealing with a large number of microdroplets in a series of multiple electrowetting pathways, and facilitates the efficient organisation of droplets from disordered droplets.

In addition, the electrowetting pathways can be arranged in such a way within a region of the microfluidic chip to maximise the space or capacity available within the region for droplet manipulation and/or control. The electrowetting pathways can be arranged in parallel, or the electrowetting pathways can be actuated by the controller to turn within the chip. The electrowetting pathways can be arranged in any suitable way in order to utilise the maximum space available within the microfluidic chip, this can be particularly useful when utilising chips with additional interior structure, such as supporting pillars.

In some embodiments, droplets can be moved between electrowetting pathways to efficiently redistribute droplets prior to the final array, this is particularly useful when droplets arrive to the initial region in a consistently uneven fashion.

In some embodiments, the microdroplets can be manipulated using oEWOD. The oEWOD manipulation of microdroplets can take place continuously, which maximises efficiency whilst eliminating the need for sequestration or holding pens.

The chip according to any one of the aspects of the invention provided herein, further comprises a first region for receiving and manipulating microdroplets and a second region comprising the array, wherein the plurality of electrowetting pathways facilitate fluid communication with the first and second regions.

In some embodiments of the chip provided herein, the electrowetting pathways are created by one or more series of moving sprite patterns.

Sprite patterns are an arrangement of one or more individual sprites, which are highly localised electrowetting fields formed from optical excitation of the photoconductive layer of the chip.

In some embodiments of the chip, the sprite number in a given pathway can be of any suitable number and may change with time, as sprites can be added or deleted from the electrowetting pathway. This enables continuous growth of the sprite patterns.

In some embodiments of the chip provided herein, each individual sprite can control a single droplet. This ensures precise control of microdroplets and their self-organisation into an array.

In some embodiments of the chip provided herein, the velocity of microdroplets in the electrowetting pathways can be 25 to 5000 μm/s. In some embodiments, the velocity of microdroplets in the electrowetting pathways can be more than 25, 50, 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 1900 or 1950, 2000, 2200, 2500, 2700, 3000, 3200, 3500, 3700, 4000, 4200, 4500, 4700 μm/s. In some embodiments, the velocity of microdroplets in the electrowetting pathways can be less than 5000, 4700, 4500, 4200, 4000, 3700, 3500, 3200 3000, 2700, 2500, 2200, 2000, 1950, 1900, 1850, 1800, 1750, 1700, 1650, 1600, 1550, 1500, 1450, 1400, 1350, 1300, 1250, 1200, 1150, 1100, 1050, 1000, 950, 900, 850, 800, 750, 700, 650, 600, 550, 500, 450, 400, 350, 300, 250, 200, 150, 100 or 50 μm/s. This enables effective manipulation of the droplets by EWOD or oEWOD force, and facilitates the self-organisation of the droplets into an ordered array.

The ordered array can be particularly useful because it allows the user to maximise the available space and/or capacity, particularly in tight compact spaces, within a region of the microfluidic chip for droplet manipulation and/or droplet control. This ordered approach allows future operations, such as droplet merges and split, to be organized efficiently.

In some embodiments of the apparatus described herein, the spacing between the electrowetting pathways can be at least double the average droplet diameter.

In some embodiments, the centre to centre spacing between the electrowetting pathways can be at least the average droplet diameter.

Providing electrowetting pathways that are at least double the average microdroplet diameter can be advantageous to allow a single microdroplet to pass between two other microdroplets. This is required in order to enable droplets which are not controlled by EWOD or oEWOD force to fall between the gaps of the microdroplets which are controlled by EWOD or oEWOD force. Therefore, this is required to achieve a sieving effect and for self-organising droplets. The sieving effect is a surprising technical effect that has arisen from the present invention. Additionally or alternatively, the gap provided between the electrowetting pathways can help reduce or minimise the risk of droplets from different electrowetting pathways coming into contact with each other. The spacing between the electrowetting pathways enable droplets to efficiently and continuously move along the pathways until the droplets are screened and selected by a user or by an automated software controller for manipulation. The operation is particularly effective when dealing with a large number of microdroplets in a series of multiple electrowetting pathways, and facilitates the efficient organisation of droplets from disordered droplets.

In some embodiments, droplets can be moved between electrowetting pathways to efficiently redistribute droplets prior to the final array, this is particularly useful when droplets arrive to the initial region in a consistently uneven fashion.

In some embodiments of the chip provided herein, the spacing between the electrowetting pathways is 2 to 4 times the average microdroplet diameter. In some embodiments of the chip provided herein, the spacing between the electrowetting pathways can be more than 2.0, 2.1, 2.2, 2.3, 2.4, 2.5, 2.6, 2.7, 2.8 or 2.9, 3, 3.2, 3.4, 3.6 or 3.8 times the average microdroplet diameter. In some embodiments of the chip provided herein, the spacing between the electrowetting pathways can be less than 4, 3.8, 3.6, 3.4, 3.2, 3.0, 2.9, 2.8, 2.7, 2.6, 2.5, 2.4, 2.3, 2.2 or 2.1 times the average microdroplet diameter. The preferred distance between the electrowetting pathways is 2.5 times the average microdroplet diameter, which prevents the spontaneous movement of droplets between electrowetting pathways without actuation by a controller.

In some embodiments of the chip provided herein, the average spherical microdroplet diameter can be 20 to 200 μm. In some embodiments, the average microdroplet diameter can be more than 20, 30, 40, 50, 60, 70, 80, 90, 100, 110, 120, 130, 140, 150, 160, 170, 180 or 190 μm. In some embodiments, the average microdroplet diameter can be less than 200, 190, 180, 170, 160, 150, 140, 130, 120, 110, 100, 90, 80, 70, 60, 50, 40 or 30 μm.

In another embodiment of the device provided herein, the average microdroplet diameter is 50 to 100 μm. In some embodiments, the average microdroplet diameter can be more than 50, 55, 60, 65, 70, 75, 80, 85, 90 or 95 μm. In some embodiments, the average microdroplet diameter can be less than 100, 95, 90, 85, 80, 75, 70, 65, 60 or 55 μm. In this context, the term “microdroplet diameter” refers to the effective spherical diameter of an unconstrained microdroplet. This is different from the apparent “diameter” of the microdroplet once it has been distorted during loading into the device.

In some embodiments, the centre to centre spacing between the electrowetting pathways is a minimum of 100 μm for a 100 μm diameter sized microdroplet. This prevents the movement of droplets between electrowetting pathways, unless actuated by the controller.

In some embodiments of the chip provided herein, the number of electrowetting pathways present is 2 to 250. In some embodiments, the number of electrowetting pathways present can be between 40 to 180, or even up to 200-250. In some embodiments, the number of electrowetting pathways present can be more than 2, 4, 6, 8, 10, 12, 14, 16, 18, 20, 22, 24, 26, 28, 30, 32, 34, 36, 38, 40, 42, 44, 46 or 48, 50, 60, 70, 80, 90, 100, 120, 140, 160, 180, 200, 210, 220, 230 or 240. In some embodiments, the number of electrowetting pathways present can be less than 250, 240, 230, 220, 210, 200, 180, 160, 140, 120, 100, 80, 60, 50, 48, 46, 44, 42, 40, 38, 36, 34, 32, 30, 28, 26, 24, 22, 20, 18, 16, 14, 12, 10, 8, 6, or 4. In some embodiments of the chip provided herein, the number of electrowetting pathways present is 3 to 10. In some embodiments, the number of electrowetting pathways present can be more than 3, 4, 5, 6, 7, 8, or 9. In some embodiments, the number of electrowetting pathways present can be less than 10, 9, 8, 7, 6, 5 or 4. In another example, approximately 180 electrowetting pathways can be provided to accommodate a droplet size of 50 μm in diameter.

In some embodiments of the chip provided herein, the two or more electrowetting pathways can propagate from the first region at differing angles.

In some embodiments of the chip provided herein, the two or more electrowetting pathways can propagate from the first region at substantially the same angle.

In some embodiments of the chip provided herein, one or more electrowetting pathways can split to form two or more electrowetting pathways. In some embodiments, one or more electrowetting pathways can be combined together to form at least one further electrowetting pathway. This facilitates the manipulation of droplets, and can enable undesired droplets to be separated from the remainder of the droplet array.

In some embodiments of the chip provided herein, the electrowetting pathways are created by a controller configured to synchronise the movement of each microdroplet in the pathways relative to the others. The controller can be a software controller. This enables the controller actuated movement of one or more microdroplets without disturbing other microdroplets in the electrowetting pathways.

According to another aspect of the present invention, there is provided an apparatus for manipulating one or more microdroplets into an array using EWOD or oEWOD, the apparatus comprising: a chip for manipulating microdroplets comprising: a plurality of electrowetting pathways leading to the array; and one or more waste electrowetting pathways leading to a waste outlet; a detector for detecting one or more microdroplets with a distinct characteristic, said detector configured to obtain a measured dataset relating to the distinct characteristic of the detected microdroplet; a storage module configured to store and maintain a stored dataset associated with the characteristic measured by the detector; and a controller configured to receive the stored dataset from the storage module and the obtained measured dataset to determine whether the measured dataset is associated with a desired or undesired characteristic; wherein the controller is configured to select one or more microdroplets having a measured dataset that is associated with an undesired characteristic and cause the one or more selected microdroplets to move into a waste electrowetting pathway. Furthermore, the controller may be configured to select one or more microdroplets having a measured dataset that is associated with a desirable characteristic and cause the one or more selected microdroplets to move into an electrowetting pathway that leads to the array.

The plurality of electrowetting pathways described herein are generated ephemerally by applying a series of selective and spatially varying electrical fields on a substrate of an EWOD apparatus. Alternatively, the plurality of electrowetting pathways described herein are generated ephemerally by applying a series of selective and spatially varying illumination of points on a photoconductive layer of an oEWOD apparatus.

A microdroplet may be considered as undesirable if the measured value of the microdroplet is associated with certain characteristics that are equal to, above or below the one or more stored threshold values set by a user. The desirability of a droplet may also be determined from a combination of characteristics, the time varying analysis of these characteristics or an average measurement of these characteristics.

The waste electrowetting pathways are electrowetting pathways which extend from a first region of the device, to outlets in the chip. In some configurations, one or more waste electrowetting pathways may stem from one or more electrowetting pathways. The waste electrowetting pathways facilitate the removal of undesired droplets from the electrowetting pathways, and remove the undesired droplets from the chip. In some embodiments, the controller is configured to select one or more microdroplets having a measured dataset that is associated with an undesired characteristic and cause the one or more selected microdroplets to move into one or more waste electrowetting pathways. In some embodiments, the controller can be configured to select one or more microdroplets having measured datasets associated with multiple undesired characteristics. For example, the controller can be configured to select one or more microdroplets which are determined to be both undersized and/or empty.

In some embodiments, the controller can be a software controller. In some embodiments, the controller can be a microcontroller.

The distinct characteristics of the detected microdroplets described herein can include, but are not limited to, the number of objects therein, droplet shape, droplet size, fluorescence or intensity of light transmitted through the droplet, which is indicative of material being contained within the microdroplet.

In some embodiments of the apparatus provided herein, the stored dataset of the storage module can be configured to store and maintain one or more threshold values associated with the one or more characteristics measured by the detector and the controller is configured to select one or more microdroplets having a measured dataset that is equal to, above or below the one or more threshold values. The threshold values can be set by a user.

The controller can be configured to select one or more microdroplets and move the selected one or more microdroplets into one or more waste electrowetting pathways. As an example, the controller may be configured to select one or more undesired microdroplets and move it into one or more waste electrowetting pathways based on the fact that the measured value of the undesired microdroplets is equal to, above or below the one or more stored threshold values set by a user.

In some embodiments, the one or more desired microdroplets having a measured value that are equal to, above or below the one or more stored threshold values set by a user are not selected by the controller and remain within the one or more electrowetting pathways.

In some embodiments, if the controller determines an ethereal electrode is not occupied by a droplet the ethereal electrode can be disabled to create additional space for path-path redistribution. This can increase the efficiency of redistribution processes such as waste removal or pre array droplet redistribution.

In some embodiments, the apparatus for manipulating one or more microdroplets into an array using EWOD or oEWOD may comprise: a chip for manipulating microdroplets comprising: a plurality of electrowetting pathways leading to the array; and one or more waste electrowetting pathways leading to a waste outlet; a detector for detecting one or more microdroplets with a distinct characteristic, said detector configured to obtain a measured dataset relating to the distinct characteristic of the detected microdroplet; a storage module configured to store and maintain a stored dataset comprising one or more threshold values that are associated with the characteristic measured by the detector; and a controller configured to receive the stored dataset from the storage module and the obtained measured dataset to determine whether the measured dataset is equal to, above or below the threshold value of the stored dataset; wherein the controller is configured to select and move one or more microdroplets having a measured dataset that is equal to, above or below the threshold value of the stored dataset into a waste electrowetting pathway.

In some embodiments of the apparatus described herein, the detector and storage module can be configured to allow adjustment of a threshold value during operation.

The controller may be configured to select one or more undesired microdroplets and cause the one or more selected microdroplets to move from the first region or the electrowetting pathways into a waste electrowetting pathway before it reaches the second region. Furthermore, the second region may be defined as a collection of array locations so that the second region is coterminous with the array. In this case, the controller may be configured to select one or more undesired microdroplets and to cause the one or more selected microdroplets to move into a waste electrowetting pathway adjacent to the second region. The diversion into the waste electrowetting pathway adjacent the array ensures that any down selected microdroplets are diverted at the point where they would have joined the array. In some embodiments, the second region may comprise a plurality of subarrays separated by waste electrowetting pathways. The controller may therefore be configured to direct a microdroplet either to one of the subarrays or into the waste electrowetting pathway as it enters the second region.

In some embodiments of the apparatus described herein, the controller can be configured to select one or more undesired microdroplets and cause the one or more selected microdroplets to move from the electrowetting pathways into a waste electrowetting pathway. In some embodiments of the apparatus described herein, the controller can be configured to select multiple undesired microdroplets and cause the multiple selected microdroplets to move from the multiple electrowetting pathways into one or more waste electrowetting pathways.

In some embodiments of the apparatus described herein, the controller can be configured to select one or more undesired microdroplets and cause the one or more selected microdroplets to move from the first region or the electrowetting pathways into a waste electrowetting pathway before it reaches the second region.

In some embodiments of the apparatus described herein, the controller can be configured to select one or more undesired microdroplets and cause the one or more selected microdroplets to move from the first or second region into a waste electrowetting pathway.

In some embodiments of the apparatus described herein, the controller can be configured to select one or more undesired microdroplets and is further configured to: move one or more undesired selected microdroplets to a space between electrowetting pathways;

move one or more undesired selected microdroplets across one or more electrowetting pathways; and move one or more undesired selected microdroplets to a waste outlet via a waste electrowetting pathway.

Configuring the controller to select one or more undesired microdroplets and move the one or more selected microdroplets across electrowetting pathways, enables undesired microdroplets to be moved without disturbing the flow of microdroplets in the electrowetting pathway.

In some embodiments of the apparatus described herein, the detector can be a bright-field imaging detector configured to detect microdroplets and to obtain the measured dataset.

In some embodiments of the apparatus described herein, the distinct characteristic measured by the detector can be microdroplet diameter, fluorescence or transmittance of light through a microdroplet.

In some embodiments, the controller can be further configured to select one or more microdroplets based on an optical label such as a fluorescent label attached to the microdroplet. In some embodiments, the controller can be configured to select one or more microdroplets containing a fluorescent object or molecule such as a stained cell or a dye.

In some embodiments of the apparatus described herein, the controller can be configured to select microdroplets which have an undesirable size. The distinct characteristic measured by the detector can be microdroplet diameter, and the controller can be configured to select one or more microdroplets having a measured dataset that is equal to, above or below the threshold values for microdroplet diameter. The threshold values for microdroplet diameter can be 0.5 to 1.5 times the expected microdroplet diameter, or the threshold values can be 0.9 to 1.1 times the microdroplet diameter. The choice of this threshold value varies depending on the requirement of the experiment, for some applications a much smaller range of 0.97 to 1.03 times the diameter may be required but this may lead to increased loading times.

In some embodiments of the apparatus described herein, the microdroplets can contain cells, and the distinct characteristic measured by the detector can be transmittance of light through the microdroplet, which can indicate whether a microdroplet contains the desired cell, or is empty. Small areas of intensity change inside the droplets can be detected. Droplets containing objects can be identified by comparing the intensity changes against stored and maintained threshold values. If the change in intensity is greater than the stored threshold value, then it can be determined that the droplet contains a small object such as a cell.

In some embodiments, the droplets can contain fluorescent reporters, and the distinct characteristic measured by the detector can be fluorescence, which can indicate the presence of the fluorescent reporter within a microdroplet, or indicate that the microdroplet is empty.

In some embodiments, the detection of one or more desired microdroplets may utilize light or optical spectroscopy such as fluorescence spectroscopy or Raman spectroscopy. In some embodiments, the detector is configured to detect the fluorescence of one or more desired microdroplets. In some embodiments, the detector can be a fluorescence detector. Additionally or alternatively, the detector can also be configured to detect fluorescently labelled undesired microdroplets.

In some embodiments of the apparatus described herein, the electrowetting pathways and/or waste electrowetting pathways can be created by a series of moving sprite patterns.

Sprite patterns are an arrangement of one or more individual sprites, which are highly localised electrowetting fields formed from optical excitation of the photoconductive layer of the chip. The sprite number in a sprite pattern can be any suitable number and may change with time, as sprites can be added or removed from the sprite pattern to facilitate the propagation of the sprite pattern and resultant electrowetting pathways or waste electrowetting pathways. In some embodiments of the apparatus described herein, each individual sprite can control a single droplet. This ensures precise control of microdroplets and their organisation into an array.

In some embodiments of the apparatus described herein, the one or more electrowetting pathways can be configured to split to form two or more electrowetting pathways. This facilitates the manipulation of droplets, and can enable undesired droplets to be separated from the remainder of the droplet array by creating the required space between electrowetting pathways for waste electrowetting pathways to be created. In some embodiments, one or more electrowetting pathways can be combined together to form at least one further electrowetting pathway. Once a waste pathway is created it runs concurrently alongside and between the array pathways, this is crucial as it allows time dependent object avoidance calculations to be avoided and allows the original load pathway to operate at a 100% fill fraction. Therefore, by following this methodology highly parallelised loading and sorting operation can be performed making high droplet number (>100s) experiments a possibility.

Furthermore, according to the present invention there is provided an apparatus for manipulating one or more microdroplets into an array using EWOD or oEWOD, the apparatus comprising: a) a chip for manipulating microdroplets comprising: i) a plurality of electrowetting pathways leading to the array; and ii) one or more waste electrowetting pathways leading to a waste outlet; b) a detector for detecting one or more microdroplets with a distinct characteristic, said detector configured to obtain a measured dataset relating to the distinct characteristic of the detected microdroplet; c) a storage module configured to store and maintain a stored dataset associated with the characteristic measured by the detector; and d) a controller configured to receive the stored dataset from the storage module and the obtained measured dataset to determine whether the measured dataset is associated with a desired or undesired characteristic; wherein the controller is configured to select one or more microdroplets having a measured dataset that is associated with an undesired characteristic and cause the one or more selected microdroplets to move into a waste electrowetting pathway; and wherein the controller is configured to control the motion of the microdroplets along and/or between the electrowetting pathways such that the movement of the microdroplets is synchronised.

Within this context, the term “synchronised” is used to describe the efficient movement of the ethereal electrodes and hence microdroplets. The movement of the microdroplets is step wise across a pixelated grid and may be near continuous. To be synchronised, the microdroplets do not necessarily have to move in the same direction, or move at all. However, when a microdroplet does move, it moves at the same time as the other moving microdroplets. Sometimes, the moving microdroplets move at substantially the same speed.

In some embodiments of the apparatus described herein, the controller is configured to form a plurality of electrowetting pathways such that the movement of each microdroplet into each of the electrowetting pathways can be synchronised relative to each other. This enables the controller actuated movement of one or more microdroplets without disturbing other microdroplets in the electrowetting pathways.

In some embodiments, a method may comprise the movement of one or more microdroplets having a measured dataset that is associated with an undesired characteristic, and preventing the one or more undesired microdroplets from forming part of the array.

In some embodiments, the microfluidic chip according to any aspects of the present invention comprises oEWOD structures comprised of: a first composite wall comprised of: a first substrate; a first transparent conductor layer on the substrate, the first transparent conductor layer having a thickness in the range 70 to 250 nm; a photoactive layer activated by electromagnetic radiation in the wavelength range 400-1000 nm on the conductor layer, the photoactive layer having a thickness in the range 300-1500 nm and a first dielectric layer on the photoactive layer, the first dielectric layer having a thickness in the range 30 to 160 nm; a second composite wall comprised of: a second substrate; a second conductor layer on the substrate, the second conductor layer having a thickness in the range 70 to 250 nm and optionally a second dielectric layer on the second conductor layer, the second dielectric layer having a thickness in the range 30 to 160 nm or 120 to 160 nm; wherein the exposed surfaces of the first and second dielectric layers are disposed less than 180 μm apart to define a microfluidic space adapted to contain microdroplets; an A/C source to provide a voltage across the first and second composite walls connecting the first and second conductor layers; at least one source of electromagnetic radiation having an energy higher than the bandgap of the photoactive layer adapted to impinge on the photoactive layer to induce corresponding virtual electrowetting locations on the surface of the first dielectric layer; and means for manipulating the points of impingement of the electromagnetic radiation on the photoactive layer so as to vary the disposition of the virtual electrowetting locations thereby creating at least one electrowetting pathway along which the microdroplets may be caused to move.

In some embodiments, the first and the second dielectric layers may be composed of a single dielectric material or it may be a composite of two or more dielectric materials. The dielectric layers may be made from, but is not limited to, Al₂O₃ and SiO₂.

In some embodiments, a structure may be provided between the first and second dielectric layers. The structure between the first and second dielectric layers can be made of, but is not limited to, epoxy, polymer, silicon or glass, or mixtures or composites thereof, with straight, angled, curved or micro-structured walls/faces.

The structure between the first and second dielectric layers may be connected to the top and bottom composite walls to create a sealed microfluidic device and define the channels and regions within the device. The structure may occupy the gap between the two composite walls.

In some embodiments, the microfluidic device may be an oEWOD device, and the oEWOD structures are comprised of: a first composite wall comprised of a first substrate a first transparent conductor layer on the substrate, the first transparent conductor layer having a thickness in the range 70 to 250 nm; a photoactive layer activated by electromagnetic radiation in the wavelength range 400-850 nm on the conductor layer, the photoactive layer having a thickness in the range 300-1500 nm and a first dielectric layer on the photoactive layer, the first dielectric layer having a thickness of below 20 nm such as between 1 nm to 20 nm; a second composite wall comprised of: a second substrate; a second conductor layer on the substrate, the second conductor layer having a thickness in the range 70 to 250 nm and optionally a second dielectric layer on the second conductor layer, the second dielectric layer having a thickness of below 20 nm such as between 1 nm to 20 nm, wherein the exposed surfaces of the first and second dielectric layers are disposed 20-180 μm apart to define a microfluidic space adapted to contain microdroplets; an A/C source to provide a voltage across the first and second composite walls connecting the first and second conductor layers; first and second sources of electromagnetic radiation having an energy higher than the band gap of the photoactive layer adapted to impinge on the photoactive layer to induce corresponding virtual electrowetting locations on the surface of the first dielectric layer; and means for manipulating the points of impingement of the electromagnetic radiation on the photoactive layer so as to vary the disposition of the virtual electrowetting locations thereby creating at least one electrowetting pathway along which the microdroplets may be caused to move. The first and second walls of these structures are transparent with the microfluidic space sandwiched in-between.

Suitably, the first and second substrates are made of a material which is mechanically strong for example glass, silicon, metal or an engineering plastic. In some embodiments, the substrates may have a degree of flexibility. In yet another embodiment, the first and second substrates have a thickness in the range 100-1500 μm, for example 500 μm or 1100 μm. In some embodiments the first substrate is comprised of one of Silicon, fused silica, and glass. In some embodiments, the second substrate is comprised of one of fused silica and glass.

The first and second conductor layers are located on one surface of the first and second substrates and typically have a thickness in the range 70 to 250 nm, preferably 70 to 150 nm. At least one of these layers is made of a transparent 20 conductive material such as Indium Tin Oxide (ITO), a very thin film of conductive metal such as silver or a conducting polymer such as PEDOT or the like. These layers may be formed as a continuous sheet or a series of discrete structures such as wires. Alternatively, the conductor layer may be a mesh of conductive material with the electromagnetic radiation being directed between the interstices of the mesh.

The photoactive layer is suitably comprised of a semiconductor material which can generate localised areas of charge in response to stimulation by the source of the second electromagnetic radiation. Examples include hydrogenated amorphous silicon layers having a thickness in the range 300 to 1500 nm. In some embodiments, the photoactive layer is activated by the use of visible light. The photoactive layer in the case of the first wall and optionally the conducting layer in the case of the second wall are coated with a dielectric layer which is typically in the thickness range from 1 to 160 nm. The dielectric layer may be composed of a single dielectric or it may be built up from a plurality of layers of different dielectrics. The dielectric properties of this layer preferably include a high dielectric strength of >10′7 V/m and a dielectric constant of >3. In some embodiments, the dielectric layer is selected from alumina, silica, hafnia or a thin non-conducting polymer film.

In another embodiment of these structures, at least the first dielectric layer, preferably both, are coated with an anti-fouling layer to assist in the establishing the desired microdroplet/carrier fluid/surface contact angle at the various virtual electrowetting electrode locations, and additionally to prevent the contents of the microdroplets adhering to the surface and being diminished as the microdroplet is moved through the chip. If the second wall does not comprise a second dielectric layer, then the second anti-fouling layer may be applied directly onto the second conductor layer.

For optimum performance, the anti-fouling layer should assist in establishing a microdroplet/carrier fluid/surface contact angle that should be in the range 50-180 when measured as an air-liquid-surface three-point interface at 25° C. In some embodiments, these layer(s) have a thickness of less than 10 nm and are typically a monomolecular layer. In another, these layers are comprised of a polymer of an acrylate ester such as methyl methacrylate or a derivative thereof substituted with hydrophilic groups; e.g. alkoxysilyl. Either or both of the anti-fouling layers are hydrophobic to ensure optimum performance. In some embodiments an interstitial layer of silica of thickness less than 20 nm may be interposed between the anti-fouling coating and the dielectric layer in order to provide a chemically compatible bridge.

The first and second dielectric layers, and therefore the first and second walls, define a microfluidic space which is at least 10 μm, and preferably in the range of 20-180 μm, in width and in which the microdroplets are contained. Preferably, before they are contained, the microdroplets themselves have an intrinsic diameter which is more than 10% greater, suitably more than 20% greater, than the width of the microdroplet space. Thus, on entering the chip the microdroplets are caused to undergo compression leading to enhanced electrowetting performance through e.g. a better microdroplet merging capability. In some embodiments the first and second dielectric layers can be coated with a hydrophobic coating such a fluorosilane.

In another embodiment, the microfluidic space includes one or more spacers for holding the first and second walls apart by a predetermined amount. Options for spacers include beads or pillars, ridges created from an intermediate resist layer which has been produced by photo-patterning. Alternatively, deposited material such as silicon oxide or silicon nitride may be used to create the spacers. Alternatively layers of film, including flexible plastic films with or without an adhesive coating, can be used to form a spacer layer. Various spacer geometries can be used to form narrow channels, tapered channels or partially enclosed channels which are defined by lines of pillars. By careful design, it is possible to use these spacers to aid in the deformation of the microdroplets, subsequently perform microdroplet splitting and effect operations on the deformed microdroplets. Similarly these spacers can be used to physically separate zones of the chip to prevent cross-contamination between droplet populations, and to promote the flow of droplets in the correct direction when loading the chip under hydraulic pressure.

The first and second walls are biased using a source of A/C power attached to the conductor layers to provide a voltage potential difference therebetween; suitably in the range 1 to 50 volts. These oEWOD structures are typically employed in association with a source of second electromagnetic radiation having a wavelength in the range 400-850 nm, for example 550, 620 and 660 nm and an energy that exceeds the bandgap of the photoactive layer. Suitably, the photoactive layer will be activated at the virtual electrowetting electrode locations where the incident intensity of the radiation employed is in the range 0.01 to 0.2 Wcm⁻².

Where the sources of electromagnetic radiation are pixelated they are suitably supplied either directly or indirectly using a reflective screen such as a digital micromirror device (DMD) illuminated by light from LEDs or other lamps. This enables highly complex patterns of virtual electrowetting electrode locations to be rapidly created and destroyed on the first dielectric layer thereby enabling the microdroplets to be precisely steered along essentially any virtual pathway using closely-controlled electrowetting forces. Such electrowetting pathways can be viewed as being constructed from a continuum of virtual electrowetting electrode locations on the first dielectric layer.

The first and the second dielectric layers may be composed of a single dielectric material or it may be a composite of two or more dielectric materials. The dielectric layers may be made from, but is not limited to, Al₂O₃ and SiO₂.

A structure may be provided between the first and second dielectric layers. The structure between the first and second dielectric layers can be made of, but is not limited to, epoxy, polymer, silicon or glass, or mixtures or composites thereof, with straight, angled, curved or micro-structured walls/faces. The structure between the first and second dielectric layers may be connected to the top and bottom composite walls to create a sealed microfluidic device and define the channels and regions within the device. The structure may occupy the gap between the two composite walls. Alternatively, or additionally, the conductor and dielectrics may be deposited on a shaped substrate which already has walls.

In some embodiments of the device provided herein, one or more microdroplets contain a biological or chemical material different to the microdroplet medium. In some embodiments of the device provided herein, the microdroplet medium can be cell media and can be selected from: F12 growth media, RPMI medium, DMEM, and Opti-MEM or EMEM.

In some embodiments of the device provided herein, the biological or chemical material is selected from: a biological cell, cell media, a chemical compound or composition, a drug, an enzyme, a bead with material optionally bound to its surface or a microsphere. In some embodiments, polystyrene or magnetic beads can be bound through Biotin-Strepdavidin bonding to antigens, antibodies or small molecules. In some embodiments, oligos can be bound as DNA tags. In some embodiments, small molecules or dye molecules can be bound with or without UV cleavable linkers.

In some embodiments of the device provided herein, the biological cells can be mammalian, bacterial, fungi, yeast, macrophage or hybridoma, and can be selected from, but are not limited to: CHO, Jurkat, CAMA, HeLa, B-cell, T-cell, MCF-7, MDAMB-231, E. coli and Salmonella. In some embodiments of the device provided herein, the chemical compound or composition can include enzymes, assay reagents, antibodies, antigens, drugs, antibiotics, lysis reagents, surfactants, dyes or cell stain. In some embodiments of the device provided herein, the biological or chemical material can be DNA oligos, nucleotides, beads/microspheres loaded or unloaded, fluorescent reporters, nanoparticles, nanowires or magnetic particles.

In some embodiments, the detection of one or more microdroplets may utilize light or optical spectroscopy such as fluorescence spectroscopy. In some embodiments, a detector can be configured to detect the fluorescence of one or more microdroplets. In some embodiments, the detector can be a fluorescence detector.

In a further aspect of the present invention, there is provided a method of manipulating microdroplets into an array using EWOD or oEWOD, the method comprising: providing a device as according to an any of the aspects of the present invention; and moving one or more microdroplets towards the array via the plurality of electrowetting pathways; wherein spacing between the electrowetting pathways is at least double the average microdroplet diameter and microdroplets move continuously in the electrowetting pathways by application of EWOD or oEWOD force without moving between electrowetting pathways.

The spacing between the electrowetting pathways must be at least double the average microdroplet diameter, to allow a single microdroplet to pass between two other microdroplets. This is required in order to achieve a sieving effect and to enable droplets which are not controlled by EWOD or oEWOD force to fall between the gaps of the microdroplets which are controlled by EWOD or oEWOD force. Therefore, this is required for a self-organising load. After the droplets have organised into an array, the spacing between the electrowetting pathways can be narrowed, and the droplets can be moved closer together.

### BRIEF DESCRIPTION OF THE FIGURES

The invention will now be further and more particularly described, by way of example only, and with reference to the accompanying drawings, in which:

FIG. 1 illustrates the chip described herein, with droplets loaded into the chip, and showing the flow direction from the inlet to the outlets;

FIG. 2 shows a plot indicating flow velocity in the chip;

FIGS. 3A to 3D show plots illustrating the effect of channel length on flow velocity within the chip;

FIGS. 4A to 4C show plots illustrating the effect of channel and outlet separation distance on the flow velocity within the chip;

FIG. 5 shows plots illustrating the combined effect of both channel length and distance between the inlet and outlet on the flow velocity within the chip;

FIG. 6 shows a chip with droplets loaded, illustrating the rapid drop off in flow velocity at the distal end of the channel, and the consequent effect on droplets;

FIG. 7 shows a loading scheme in which a chip is loaded with droplets and an electrowetting pattern created by an application of ephemeral EWOD or oEWOD force is generated;

FIG. 8 shows the chip, with the electrowetting pattern passing over the droplets at the distal channel end;

FIG. 9 shows the chip, with droplets picked up by the electrowetting pattern and becoming ordered;

FIG. 10 shows the chip, with an ordered array of droplets facilitated by the electrowetting pattern;

FIG. 11 shows a series of moving sprite patterns which pick up microdroplets, and create electrowetting pathways leading to a self-organised array of microdroplets;

FIG. 12 shows electrowetting pathways created by one or more series of moving sprite patterns, and the electrowetting pathways propagating from the first region of the chip at substantially the same angle;

FIG. 13A shows a sprite pattern in which sprites are created at the corners of the sprite pattern as the sprites move;

FIG. 13B illustrates how creating sprites at the corners of a sprite pattern can create propagation of the sprite patterns at differing angles;

FIG. 13C shows electrowetting pathways propagating from the first region of the chip in differing directions;

FIG. 14A shows microdroplets within an electrowetting pathway, and the electrowetting pathway splitting into three electrowetting pathways to create space for waste electrowetting pathways in between;

FIG. 14B shows an undesired droplet in an electrowetting pathway alongside desired droplets;

FIG. 14C shows the undesired droplet being moved into a waste electrowetting pathway;

FIG. 14D shows the undesired droplet being moved from the waste electrowetting pathway and crossing an electrowetting pathway without disturbing the desired droplets in that electrowetting pathway;

FIG. 14E shows the undesired droplet being moved from the electrowetting pathway into a waste electrowetting pathway;

FIG. 14F shows the undesired droplet being moved from the waste electrowetting pathway into an electrowetting pathway without disturbing the desired droplets in that electrowetting pathway;

FIG. 14G shows the undesired droplet being moved out of the electrowetting pathway, where it can then be transferred to a waste outlet via a waste electrowetting pathway;

FIG. 15 shows an electrowetting pathway formation with the diverging and splitting of a plurality of electrowetting pathways, and creation of waste electrowetting pathways between the split electrowetting pathways;

FIG. 16 shows an alternative electrowetting pathway formation, in which the diverging of electrowetting pathways creates sufficient space to form waste electrowetting pathways between the electrowetting pathways, and the initial number of electrowetting pathways is maintained;

FIG. 17 shows electrowetting pathways and waste electrowetting pathways travelling alongside each other from a first region of the chip into a second region of the chip, with the waste electrowetting pathways travelling to outlets in the chip;

FIG. 18 shows an alternative electrowetting pathway formation in which sprites are created at the corners of a sprite pattern and which results in electrowetting pathways propagating from a first region of the chip at differing angles; and

FIG. 19a shows droplets being loaded into the chip;

FIG. 19b shows the transfer of droplets to oEWOD control via a propagating light pattern of sprites and the beginnings of droplet self-ordering;

FIG. 19c shows the spacing of electrowetting pathways to allow room for waste electrowetting pathways between;

FIG. 19d shows an undesirable oversized droplet reaching the divergence point for movement onto a waste electrowetting pathway;

FIG. 19e shows the undesirable oversized droplet moved into a waste electrowetting pathway; and

FIG. 19f shows the undesirable oversized droplet continuing to be transported along a waste electrowetting pathway including directional changes in that pathway.

### DETAILED DESCRIPTION OF FIGURES

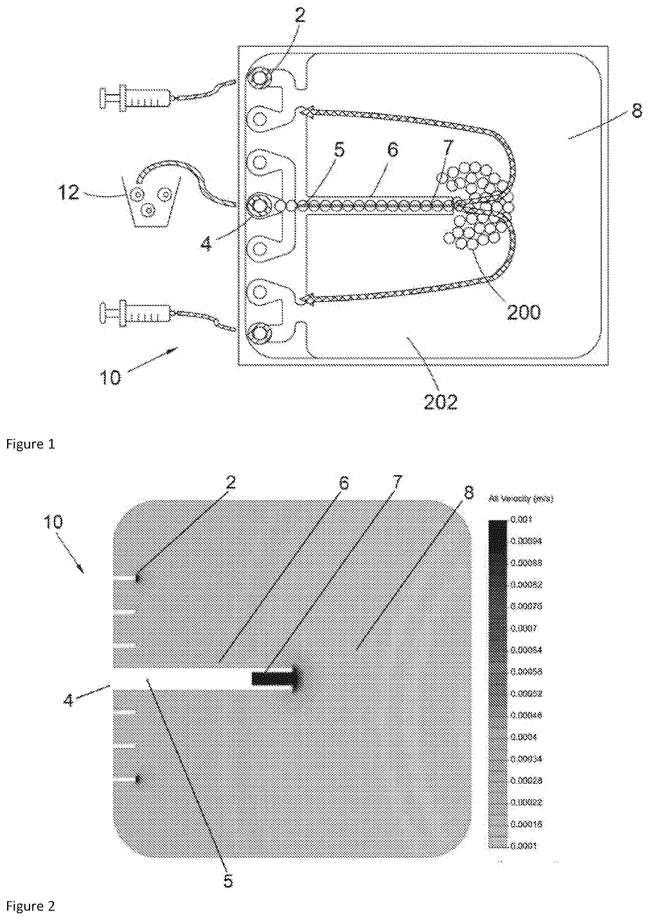

FIG. 1 depicts a chip 10 according to the present invention. The chip 10 comprises a droplet reservoir 12 which is connected to an inlet end 4 in the chip 10. The reservoir 12 is provided to store multiple microdroplets 200. The microdroplets may contain one or more biological or chemical materials different to the microdroplet medium. The microdroplet medium can be cell media including F12 growth media, RPMI medium, DMEM, and Opti-MEM or EMEM. The chemical or biological material contained within the microdroplet medium can be a biological cell, cell media, a chemical compound or composition, a drug, an enzyme, a bead with material optionally bound to its surface or a microsphere. More specifically, cells can be mammalian, bacterial, fungi, yeast, macrophage, hybridoma and can be selected from, but are not limited to: CHO, Jurkat, CAMA, HeLa, B-cell, T-cell, MCF-7, MDAMB-231, E. coli or Salmonella. Chemical material contained within microdoplets can be enzymes, assay reagents, antibodies, antigens, drugs, antibiotics, lysis reagents, surfactants, dyes or cell stain. Other biological or chemical materials which may be contained within the microdroplets include DNA oligos, nucleotides, beads/microspheres loaded or unloaded, fluorescent reporters, nanoparticles, nanowires or magnetic particles.

Connected to the inlet is a channel 6 which is designed for loading one or more droplets 200 into the chip 10. At the distal end of the channel 7 there is first region 8, where droplets can be manipulated via EWOD or oEWOD forces. In addition, there is also provided a second region 202 within the device 10 comprising droplets 200 which can be organised into an array. The channel 6 may be blunted or fluted at the distal end 7. Alternatively the channel 6 may be tapered, or may be substantially the same width the entire length. The chip also comprises at least one outlet end 2 which enables the flow to be directional from the inlet 4 and distal channel end 7, to the outlets 2, as indicated by the arrows in FIG. 1. The chip 10 may comprise two or more outlets 2, and in some embodiments, at least one outlet is positioned on either side of the channel 6.

The inclusion of an inlet 4 and an outlet 2 can be important to create a directional flow on the chip 10, the velocity of which is illustrated by a plot in FIG. 2. As shown in FIG. 2, the elongate channel 6 substantially extends in a first direction into the first region 8 of the chip 10. The fluid flow containing one or more microdroplets can be pumped or aspirated out of the reservoir 12 and into the channel 6 at the inlet end 4 of the channel 6. The velocity of the fluid flow at the proximal end 5 of the channel 6 is relatively high and can be at a constant velocity. As the fluid flow containing one or more microdroplets move further along the channel 6 and towards the distal end 7 of the channel 6, the velocity of the fluid flow containing one or more microdroplet at the distal end 7 of the channel 6 is substantially lower than the velocity of the fluid flow at the proximal end 5 of the channel 6. In some instances, the velocity of the microdroplets at the distal end 7 of the channel 6 can be zero or near zero such that the droplets loaded into the chip 10 will effectively come to a stop, or to a near stop, at the distal end 7 of the channel 6. The distal end 7 of the channel 6 may also be blunted or fluted to maximise the reduction in flow rate and/or velocity of the fluid flow.

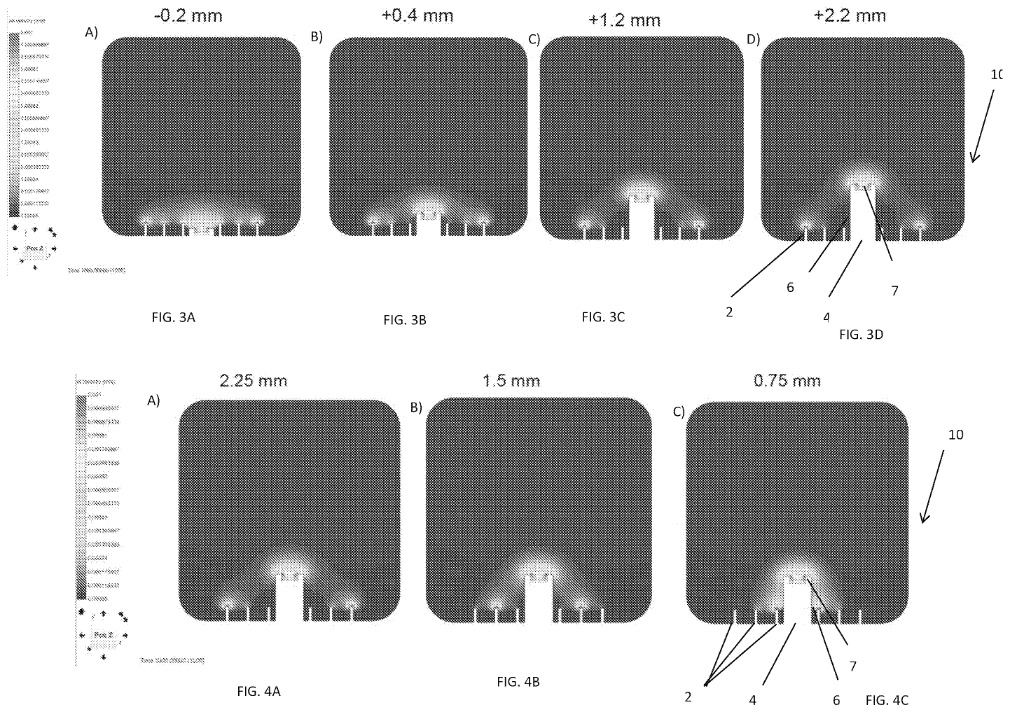

The length of the channel 6 is an important parameter of the chip 10, as illustrated by the plots shown in FIG. 3. FIG. 3 demonstrates the effect of differing channel 6 length on the velocity within the chip 10. In FIG. 3, the outlets 2 are fixed at a position of 2.25 mm from the inlet 4. The channel length 6 can be recessed 0.2 mm with respect to the outlet 2 as shown in FIG. 3A, can extend into the chip 10 by 0.4 mm with respect to the outlet 2 as shown in FIG. 3B, can extend into the chip 10 by 1.2 mm with respect to the outlet 2 as shown in FIG. 3C and can extend into the chip 10 2.2 mm with respect to the outlet 2 as shown in FIG. 3D. FIG. 3C shows that the channel 6 is required to extend a minimum of 1.2 mm into the chip 10 with respect to the outlet in order to prevent a continuous flow travelling between the distal end of the channel 7 and outlets 2.

Another important parameter of the chip 10, is the distance between the inlet 4 and outlets 2. Referring to FIGS. 4A to C, there is provided plots demonstrating the effect of inlet 4 and outlet 2 separation distances on the velocity within the chip 10. In FIGS. 4A to 4C, the length of the channel 6 is fixed. The inlet 4 and outlet 2 can be separated by a distance of 2.25 mm as shown in FIG. 4A, can be separated by 1.5 mm as shown in FIG. 4B, or can be separated by a distance of 0.75 mm, as shown in FIG. 4C. FIG. 4A shows that a minimum inlet 4 and outlet 2 separation distance of 2.25 mm is required in order to prevent a continuous flow between the between the distal end of the channel 7 and outlets 2, which would prevent droplets loaded into the chip 10 from coming to an effective stop at the distal end of the channel 7.

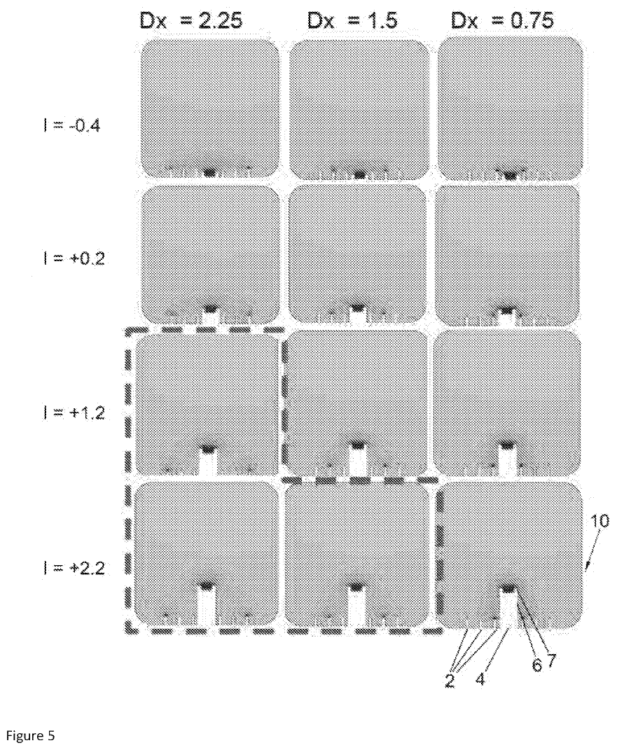

The combined effect of the length of the channel 6 and distance between the inlet 4 and outlets 2 on velocity is shown in FIG. 5. When the distance between the inlet 4 and the outlets 2 is 2.25 mm, a minimum channel length 6 of 1.2 mm with respect to the outlet 2 is necessary so as not to generate a continuous flow between the distal end of the channel 7 and outlets 2. When the distance between the inlet 4 and outlets 2 is decreased to 1.5 mm, the minimum required channel length 6 increases to a 2.2 mm extension into the chip with respect to the outlet 2, whilst a distance of 0.75 mm between the inlet 4 and outlets 2 is not suitable for use with the channel lengths 6 investigated.

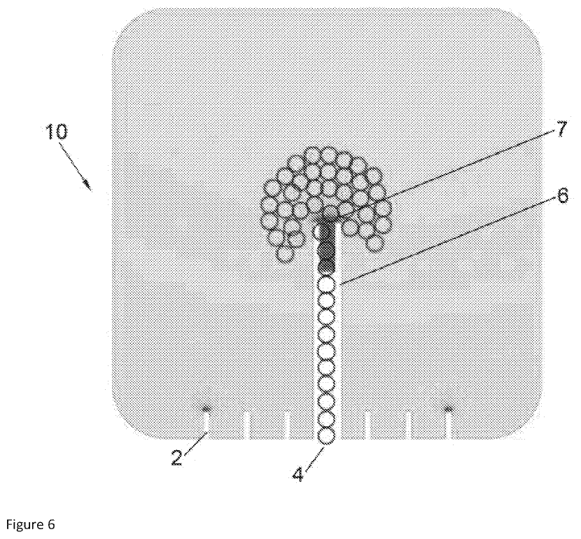

When droplets are loaded into the channel 6 through the inlet 4, the droplets will effectively stop at the distal channel end 7 because of an area of low flow velocity. The effect of velocity on droplets loaded into the chip 10 is shown in FIG. 6, which shows the droplets fanning out from the distal channel end 7, owing to the near zero velocity region. This near zero velocity region enables the droplets to stop moving and be taken out of flow control, and facilitates transfer of the droplets to EWOD or oEWOD control.

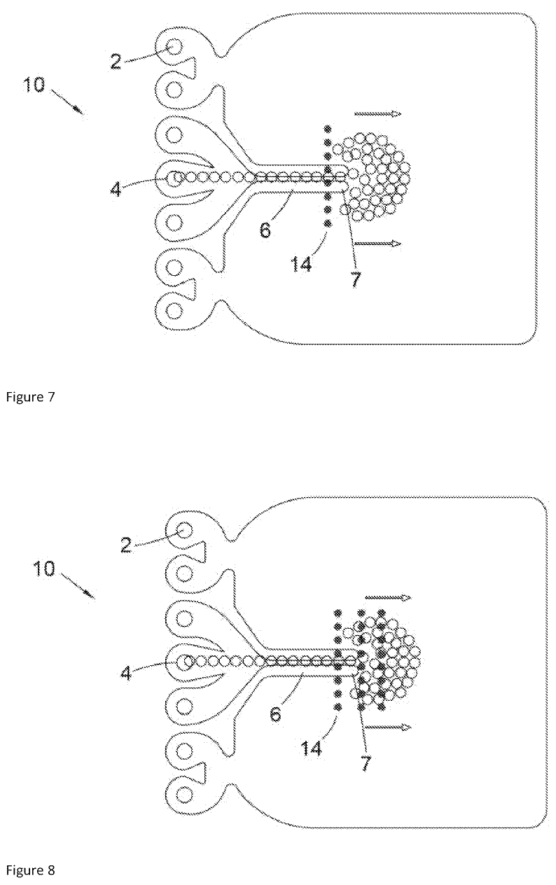

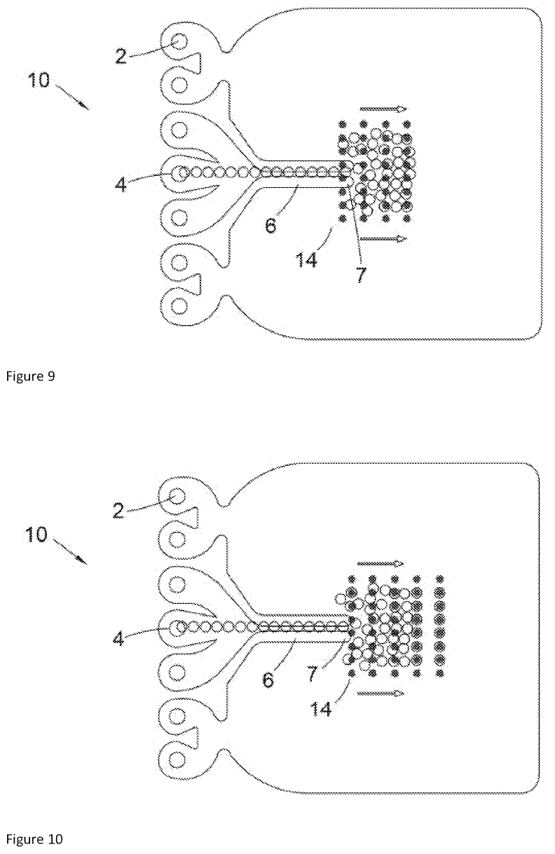

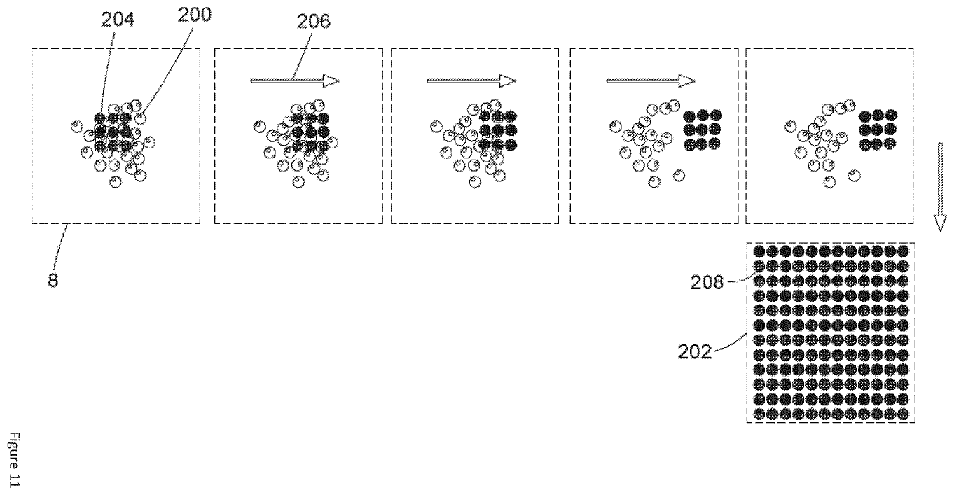

An example of how the droplets can be effectively manipulated and/or controlled from the distal end 7 of the elongated channel 6 within the chip 10 is to produce an ordered array using a plurality of electrowetting pathways created by an application of ephemeral EWOD or oEWOD force at positions along the pathway, as shown in FIGS. 7 to 10. In order to take control of the droplets using EWOD or oEWOD, a series of EWOD or oEWOD electrowetting patterns 14 are generated, as shown in FIG. 7. The electrowetting patterns 14 are shifted over the disordered droplets at the distal channel end 7 as shown in FIG. 8, and as the electrowetting pattern 14 passes over the droplets, the droplets are pulled from the distal channel end 7 and picked up by the electrowetting pattern 14. The electrowetting pattern 14 animates the pattern so that the disordered droplets self-assemble into an ordered array as shown in FIGS. 9 and 10. Droplets which are not yet controlled by EWOD or oEWOD force, fall between the gaps of the electrowetting pattern 14, and a sieving effect is achieved. To achieve this sieving effect, the spacing between the series of electrowetting patterns 14 is at least double the average microdroplet diameter. After the droplets have self-organised into an array, the spacing between the electrowetting patterns 14 can be narrowed, and the droplets can be moved closer together. The loading and manipulation of the droplets using EWOD or oEWOD as described herein can be continuous and parallelised.

FIG. 11 provides an illustration of one or more series of sprite patterns 204 in the first region of the device 8. The one or more series of sprite patterns 204 can be generated using EWOD or oEWOD forces, which can overlay at the position of the microdroplets 200 at the distal end 7 of the channel 6, as illustrated in FIG. 2. The sprite patterns 204 are shifted over the droplets 200, and the droplets 200 are picked up by the sprite patterns 204 without active detection, achieving an efficient passive loading of droplets 200 onto the sprite pattern 204. Each individual sprite can control a single droplet. Individual sprites which do not pick up a microdroplet can be removed. The sprite patterns 204 animate the droplets 200, and create electrowetting pathways 206, as shown in FIG. 11, in which highly localised electrowetting fields are capable of moving the microdroplets 200 on the surface of the dielectric layer of the chip 10 by induced capillary-type forces.

Whilst in the electrowetting pathways 206, droplets 200 which are not yet controlled by EWOD or oEWOD force, fall between the gaps of the sprite pattern 204, and a sieving effect is achieved. The electrowetting pathways 206 transport the droplets 200 to a second region of the device 202, where the droplets 200 are organised into an array 208.

The loading and manipulation of the droplets 200 using EWOD or oEWOD as described herein can be continuous and parallelised.

For high throughput applications, microdroplets 200 in the order of millions are required to be loaded and manipulated on chip 10 efficiently. It is necessary to be able to manipulate (including controlling the movement, merging, splitting or changing shape of microdroplets), sort and divert droplets 200 within the chip 10. For example, it is necessary to be able to divert individual droplets which are deemed undesired, and move these undesired droplets to an outlet 2 in the chip 10 so that they are prevented from forming part of the droplet array 208.

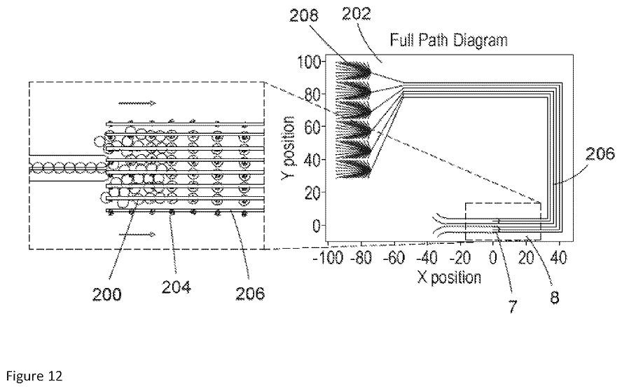

In a device designed to process millions of microdroplets 200 at a time, the movement and sorting of microdroplets 200 must make effective use of space on chip 10. As shown in FIG. 12, one configuration of electrowetting pathways 206 which can be used to transport and sort microdroplets 200, whilst making effective use of space on chip 10, involves a plurality of electrowetting pathways 206 propagating from a first region of the device 8 at substantially the same angle. The initial number of electrowetting pathways 206 can be the same as the final number of electrowetting pathways 206, or an electrowetting pathway 206 can split into two or more electrowetting pathways 206, which allows continuous propagation of the electrowetting pathways 206 and the continuous pick up of droplets 200 from the distal end 7 of the channel 6. The electrowetting pathways 206 are created by a controller, which can be a software controller, and which can be configured to synchronise the movement of each microdroplet 200 in the electrowetting pathways 206 relative to the others. This ensures that each microdroplet 200 moves in the electrowetting pathway 206 without disturbing other microdroplets 200 in the electrowetting pathways 206.

The electrowetting pathways 206 can be actuated via the controller to optimise the space used on chip 10. The microdroplets 200 move continuously in the electrowetting pathways 206 without moving between electrowetting pathways 206 unless actuated to do so via the controller, because a minimum spacing of at least double the microdroplet diameter is maintained between the electrowetting pathways 206.

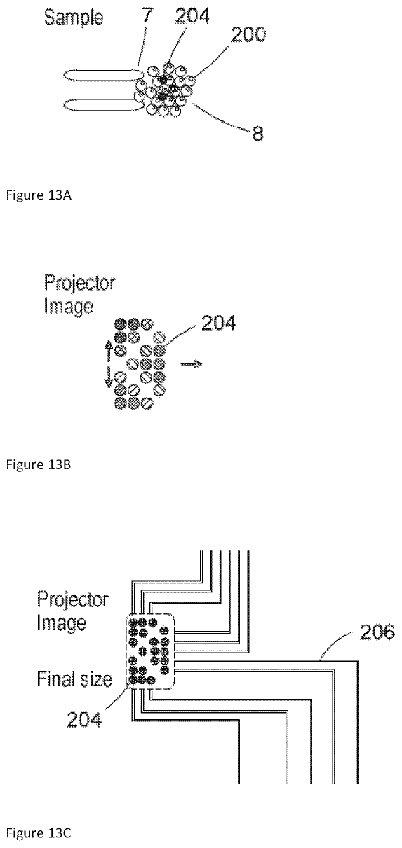

An alternative embodiment of the electrowetting pathway configuration can be created by adding sprites to the corners of the sprite patterns 204, as the sprites move over the microdroplets 200 at the distal end 7 of the channel 6 in the first region of the device 8, as shown in FIG. 13A. Adding sprites to the corners of sprite patterns 204 as droplets 200 are picked up and loaded onto sprites, creates sprite patterns 204 which propagate at differing angles, as shown in FIG. 13B.

FIG. 13C shows a plurality of electrowetting pathways 206 propagating in different directions from the first region of the device 8, created by the series of moving sprite patterns 204 propagating at differing angles. Electrowetting pathways 206 propagating in different directions can optimise the use of space on chip 10 and can enable droplets 200 to be loaded onto sprite patterns 204 in multiple directions simultaneously.

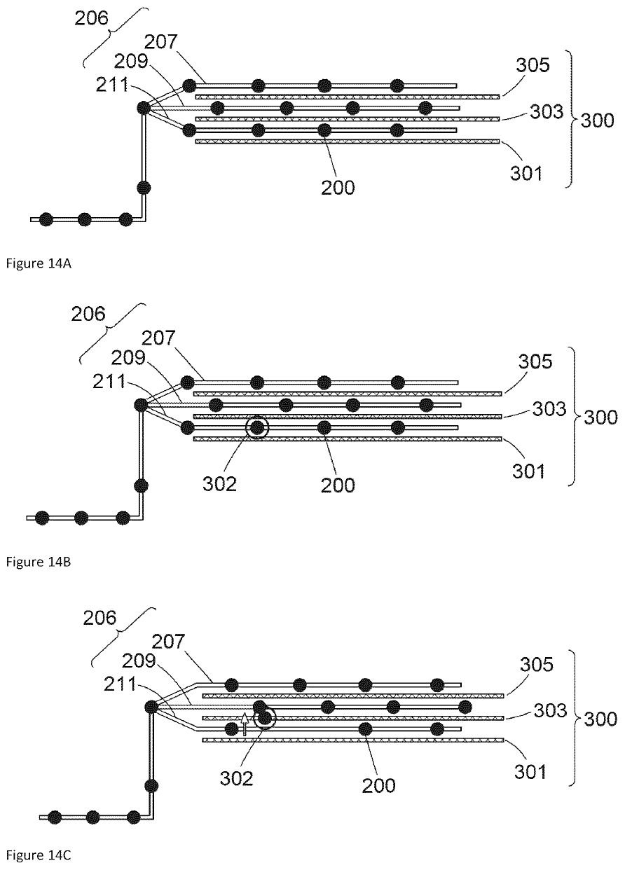

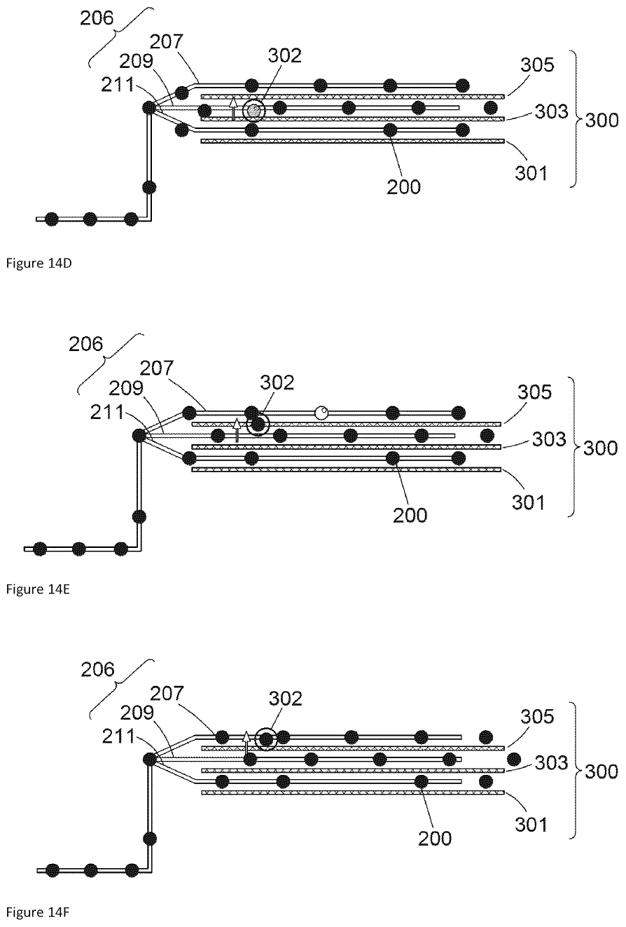

Referring to FIG. 14A, droplets 200 can be removed from the chip via waste electrowetting pathways 300 which are created by the controller between the electrowetting pathways 206. In order to ensure there is sufficient spacing between the electrowetting pathways 206 and waste electrowetting pathways 300, the electrowetting pathways 206 can split into two or more electrowetting pathways 207, 209 and 211, to create space for the waste electrowetting pathways 300 to be created in between.

A detector can be configured to identify undesired droplets 302 from a plurality of droplets 200 flowing along electrowetting pathway 211, as shown in FIG. 14B. Undesired droplets 302 could include, but are not limited to droplets 200 with a diameter above or below a threshold diameter, or droplets 200 which are determined to not contain the desired contents or number of contents such as particles, chemical materials or biological cells, by measuring transmittance or fluorescence.

As illustrated in FIGS. 14A to 14G, the plurality of electrowetting pathways 207, 209, 211 can diverge from their initial formation, at angles of 0 to 90°, to provide sufficient space for the waste electrowetting pathways 301, 303, 305 to be formed in between.

In order to remove undesired droplets 302 from the electrowetting pathways 206, so that they do not form part of the final array 208, the controller can be configured to select one or more undesired microdroplets 302 and cause the one or more selected undesired microdroplets 302 to move across a first waste electrowetting pathway 303 as shown in FIG. 14C.

The controller synchronises the movement of the undesired droplet 302 compared to other droplets 200 in the electrowetting pathways 206, and the undesired droplet 302 can be moved across a first electrowetting pathway 209 without disturbing the droplets 200 in flow in the electrowetting pathway 209, as shown in FIG. 14D.

The controller can move the undesirable droplet 302 across additional waste electrowetting pathways 305 as shown in FIG. 14E, and additional electrowetting pathways 207 as shown in FIG. 3F, without disturbing droplets 200 in flow in the electrowetting pathways 207. This process can be continued until the undesired droplet 302 is no longer between two electrowetting pathways 206 as shown in FIG. 14G. The undesired droplet 302 can then be moved to an outlet 2 in the chip 10 via a waste electrowetting pathway 300.

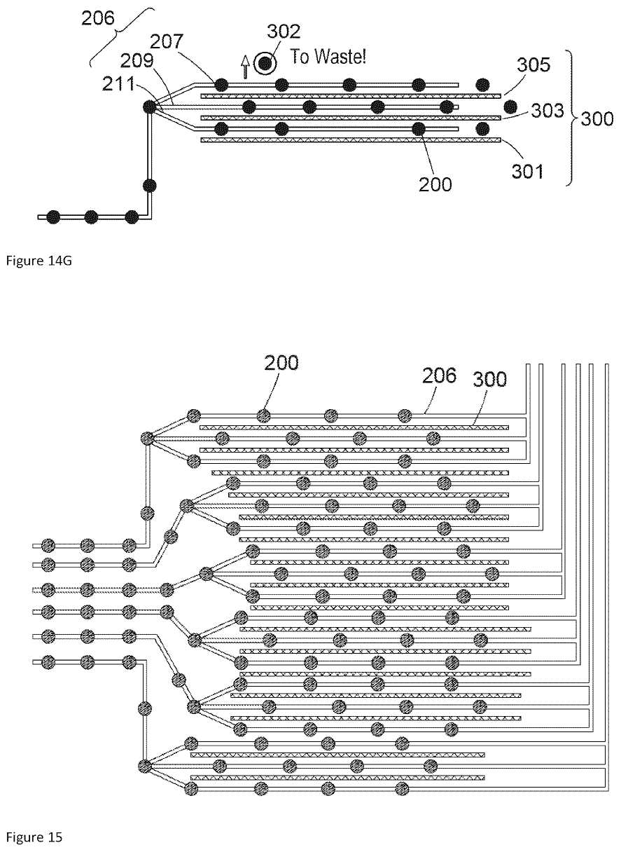

FIG. 15 provides an illustration of a plurality of electrowetting pathways 206 and a plurality of waste electrowetting pathways 300. The plurality of electrowetting pathways diverges at one end from their initial formation, at angles of 0 to 90°, to provide sufficient space for the waste electrowetting pathways 300 to be formed in between as illustrated in FIG. 15. The spacing between each electrowetting pathway 206 can be at least double the average droplet diameter to help reduce or minimise the risk of droplets 200 from different electrowetting pathways 206 coming into contact with each other. In some embodiments, the spacing between the electrowetting pathways 206 can be at least 100 μm. The electrowetting pathways 206 are vertically spread, with a horizontal offset of one array spacing. To remove an undesired droplet 302 from the electrowetting pathways 206 in the centre of the formation illustrated in FIG. 15, the controller can move the undesired droplet 302 across half the total number of electrowetting pathways 206, in order to remove the unwanted droplet 302 to a waste outlet 300.

In this embodiment, the undesired droplets 302 can be selected by the controller and removed from the chip 10 early on in the droplet manipulation process in order to prevent the undesired droplets 302 having to be carried alongside desired droplets 200, saving space on the chip 10. Undesired droplets 302 are removed from the electrowetting pathways 206 in a first region of the device 8 before they reach a second region of the device 202, and are therefore prevented from forming part of the array 208 in the second region of the device 202.

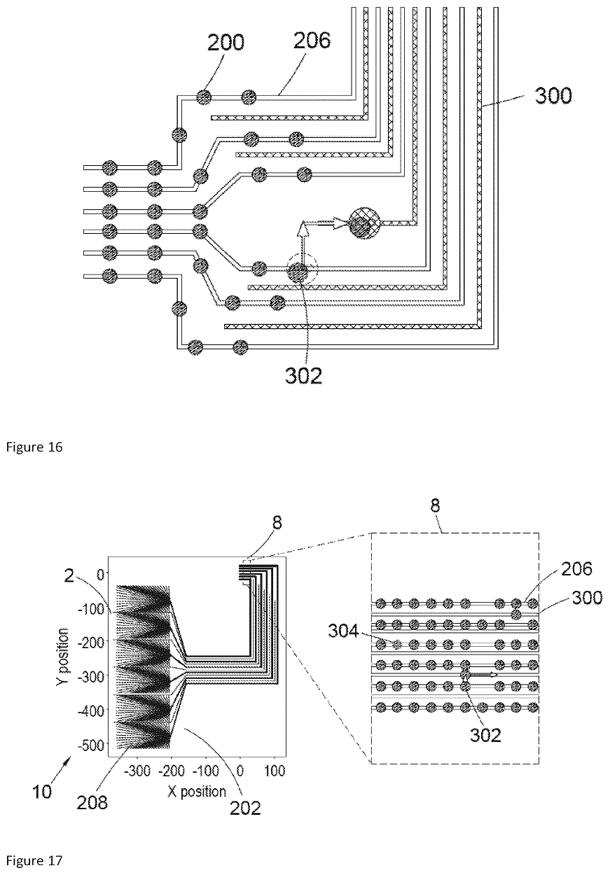

In an alternative embodiment, waste electrowetting pathways 300 can be introduced between electrowetting pathways 206 whilst maintaining the initial number of electrowetting pathways 206, as shown in FIG. 16. Electrowetting pathways 206 diverge diagonally from their initial formation at angles of 0 to 90°, until sufficient space is created for the controller to create waste electrowetting pathways 300 between the electrowetting pathways 206. Vertically spread electrowetting pathways 206 with a horizontal offset equal to one array spacing are formed.

One or more undesired droplets 302 can be moved by the controller into one or more waste electrowetting pathways 300 and carried in the waste electrowetting pathways 300 into a second region of the device 202. The spacing between electrowetting pathways 206 and waste electrowetting pathways 300 is at least double the average microdroplet diameter, to prevent microdroplets 200 crossing pathways without actuation by the controller.

As shown in FIG. 17, the electrowetting pathways 206 and waste electrowetting pathways 300 are aligned in parallel with each other from the first region of the device 8, and into the second region of the device 202. The electrowetting pathways 206 carry the droplets 200 to form an array 208, whilst the waste electrowetting pathways 300 carry the undesired droplets 302 to outlets 2 in the chip 10. Since the waste electrowetting pathways 300 and electrowetting pathways 206 are in parallel with each other in the first region 8 and second region 202 of the chip 10, it is possible for the controller to select and move one or more undesired microdroplets 302 in both the first region 8 and second regions 202 of the chip 10, into a waste electrowetting pathway 300. Individual sprites which are not controlling a microdroplet 304 can be removed.

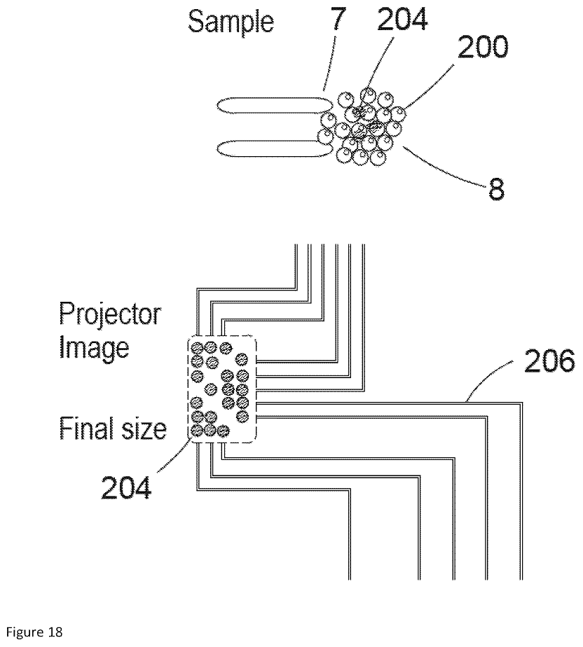

Both the electrowetting pathway embodiments illustrated by FIG. 15 and FIG. 16 show electrowetting pathways 206 which propagate from a first region 8 of the chip 10 at substantially the same angle. According to an alternative embodiment of the apparatus as shown in FIG. 18, the electrowetting pathways 206 can propagate from the first region 8 of the chip 10 at differing angles. Sprites are added at the corners of sprite patterns 204 as they pick up microdroplets 200 in the first region of the device 8, which causes the sprite patterns 204 to propagate at differing angles. The resultant electrowetting pathways 206 propagate in different directions which can optimise the use of space in the chip 10 and enables droplets 200 to be loaded in multiple directions simultaneously.

The filtering of undesired microdroplets 302 in electrowetting pathways 206 propagating at differing angles can occur through the same steps as illustrated by FIG. 14, FIG. 15 and FIG. 16. Electrowetting pathways 206 propagating at differing angles from a first region of the device 8 can diverge at angles of 0 to 90° until sufficient space is created to split each electrowetting pathway 206 into two or more electrowetting pathways 206, and form waste electrowetting pathways 300 in between. Undesired droplets 302 can be removed from the electrowetting pathways 206 propagating at differing angles by movement of the undesired droplets 302 across electrowetting pathways 206 and waste electrowetting pathways 300 in a first region of the device 8. Or the electrowetting pathways 206 propagating at differing angles can diverge at angles of 0 to 90° until sufficient space is created to form waste electrowetting pathways 300 in between, without splitting of the electrowetting pathways 206. Undesired droplets 302 can be removed from the electrowetting pathways 206 by moving the undesired droplets 302 into the waste electrowetting pathways 300 in a first region 8 or second region 202 of the device. The waste electrowetting pathways 300 can carry the undesired droplets 302 to outlets 2 in the chip 10.

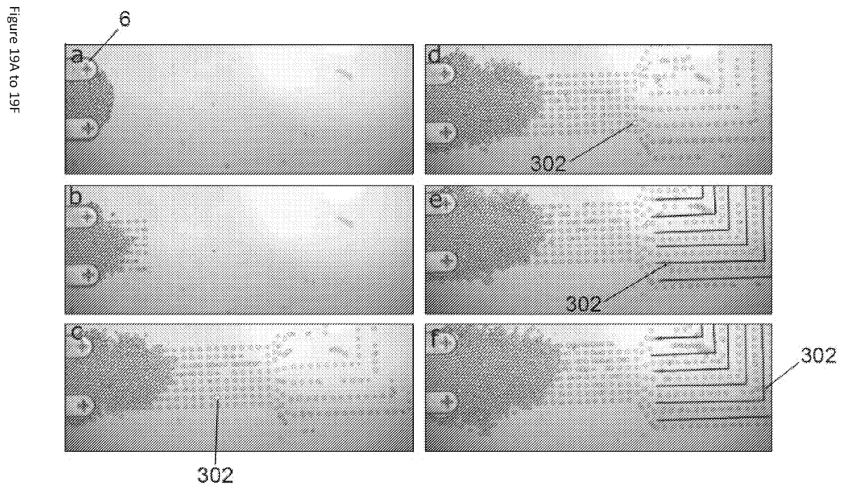

An example of an oversized, undesirable microdroplet 302 being selected by the controller and moved into a waste electrowetting pathway 300 is shown in FIGS. 19a to 19f. Droplets 200 are loaded into the chip 10 through the channel 6 and fan out from the channel end as shown in FIG. 19a. The droplets 200 are transferred to oEWOD control via a propagating light pattern of sprites 204, and the droplets 200 begin to self-order, as shown in FIG. 19b. The electrowetting pathways 206 diverge to create space for the waste electrowetting pathways 300 in between, as shown in FIG. 19c. An undesirable, oversized droplet 302 being transported in electrowetting pathways 206 with desired microdroplets 200, reaches the divergence point for movement onto a waste electrowetting pathway 300 as shown in FIG. 19d. The undesired microdroplet 302 can be actuated by the controller to move into a waste electrowetting pathway 300, as shown in FIG. 19e. The undesirable, oversized droplet 302 continues to be transported along a waste electrowetting pathway 300 including when there are directional changes in that pathway, and can be delivered to a waste outlet 2 in the chip 10, preventing the undesired droplet 302 from forming part of the array 208.

Various further aspects and embodiments of the present invention will be apparent to those skilled in the art in view of the present disclosure.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described.

It will further be appreciated by those skilled in the art that although the invention has been described by way of example with reference to several embodiments, it is not limited to the disclosed embodiments and that alternative embodiments could be constructed without departing from the scope of the invention as defined in the appended claims.

1-21. (canceled)

22. An apparatus for manipulating one or more microdroplets into an array of microdroplets using EWOD or oEWOD, the apparatus comprising:
a) a chip for manipulating microdroplets comprising:
i) a plurality of electrowetting pathways leading to the array of microdroplets; and
ii) one or more waste electrowetting pathways leading to a waste outlet;
b) a detector for detecting one or more microdroplets with a distinct characteristic, said detector configured to obtain a measured dataset relating to the distinct characteristic of the detected microdroplet;
c) a storage module configured to store and maintain a stored dataset associated with the characteristic measured by the detector; and
d) a controller configured to receive the stored dataset from the storage module and the obtained measured dataset to determine whether the measured dataset is associated with a desired or undesired characteristic;
wherein the controller is configured to select one or more microdroplets having a measured dataset that is associated with an undesired characteristic and cause the one or more selected microdroplets to move into a waste electrowetting pathway; and
wherein the controller is configured to control the motion of the microdroplets along and/or between the electrowetting pathways such that the movement of the microdroplets is synchronised.

23. The apparatus according to claim 22, wherein the chip further comprises a first region for receiving and manipulating microdroplets and a second region comprising the array, wherein the plurality of electrowetting pathways can facilitate the movement of microdroplets between the first and second regions.

24. The apparatus according to claim 22, wherein the stored dataset of the storage module is configured to store and maintain one or more threshold values associated with the characteristic measured by the detector and the controller is configured to select one or more microdroplets having a measured dataset that is equal to, above or below the one or more threshold values; and wherein the detector and storage module are configured to allow adjustment of a threshold value during operation.

25. The apparatus according to claim 22, wherein the controller is configured to select one or more undesired microdroplets and cause the one or more selected microdroplets to move from the electrowetting pathways into a waste electrowetting pathway.

26. The apparatus according to claim 22, wherein the controller is configured to select one or more undesired microdroplets and cause the one or more selected microdroplets to move from the first region or the electrowetting pathways into a waste electrowetting pathway before it reaches the second region.

27. The apparatus according to claim 22, wherein the controller is configured to select one or more undesired microdroplets and cause the one or more selected microdroplets to move from the first or second region into a waste electrowetting pathway.

28. The apparatus according to claim 22, wherein the controller is configured to select one or more undesired microdroplets and is further configured to:
a) move one or more undesired selected microdroplets to a space between electrowetting pathways;
b) move one or more undesired selected microdroplets across one or more electrowetting pathways; and
c) move one or more undesired selected microdroplets to a waste outlet via a waste electrowetting pathway.

29. The apparatus according to claim 22, wherein the detector is a bright-field imaging detector configured to detect microdroplets and to obtain the measured dataset.

30. The apparatus according to claim 22, wherein the distinct characteristic measured by the detector is one or more of the following: the number of objects contained therein; microdroplet diameter; fluorescence or transmittance of light through the microdroplet.

31. The apparatus according to claim 22, wherein the detector is configured to detect the fluorescence of one or more desired microdroplets.

32. The apparatus according to claim 22, wherein the electrowetting pathways and/or waste electrowetting pathways are created by a series of moving sprite patterns.

33. The apparatus according to claim 32, wherein each individual sprite controls a single droplet.

34. The apparatus according to claim 22, wherein centre to centre spacing between the electrowetting pathways is at least the average droplet diameter.

35. The apparatus according to claim 22, wherein the average spherical microdroplet diameter is 20 to 200 μm.

36. The apparatus according to claim 22, wherein the number of electrowetting pathways is 2 to 250.

37. The apparatus according to claim 22, wherein two or more electrowetting pathways propagate from the first region at differing angles.

38. The apparatus according to claim 22, wherein two or more electrowetting pathways propagate from the first region at substantially the same angle.

39. The apparatus according to claim 22, wherein one or more electrowetting pathways is configured to split to form two or more electrowetting pathways.

40. The apparatus according to claim 22, wherein one or more of the microdroplets comprises a biological or chemical material which is one or more of the following: a biological cell, cell media, a chemical compound or composition, a drug, an enzyme, a bead or a microsphere optionally bound to a surface and/or to a second material.

41. A method of manipulating one or more microdroplets into an array using EWOD or oEWOD, the method comprising:
a) providing an apparatus according claim 22; and
b) moving one or more microdroplets towards the array via the plurality of electrowetting pathways by the application of EWOD or oEWOD force.
